(19) United States
(12) Patent Application Publication
(10) Pub. No.: US 2019/0284082 A1
(43) Pub. Date: Sep. 19, 2019

(54) FORMING BODIES FOR FORMING CONTINUOUS GLASS RIBBONS AND GLASS FORMING APPARATUSES COMPRISING THE SAME

(71) Applicant: CORNING INCORPORATED, CORNING, NY (US)

(72) Inventors: Olus Naili Boratav, Ithaca, NY (US); Ahdi EI-Kahlout, Lexington, KY (US); Timothy L. Lansberry, Watkins Glen, NY (US); Steven Michael Milillo, State College, PA (US); Eunyoung Park, Taipei (TW); Paul Maynard Schermerhorn, Painted Post, NY (US); William Anthony Whedon, Corning, NY (US)

(21) Appl. No.: 16/463,094

(22) PCT Filed: Nov. 21, 2017
(86) PCT No.: PCT/US17/62692

§ 371 Date: May 22, 2019

Related U.S. Application Data
(60) Provisional application No. 62/425,295, filed on Nov. 22, 2016.

(51) Int. Cl. C03B 17/06

(52) U.S. Cl. CPC C03B 17/064

(57) ABSTRACT

A forming body of a glass forming apparatus is disclosed having an upper portion, a first forming surface, and a second forming surface extending downward from the upper portion to converge at a root. The upper portion of the forming body includes a trough for receiving molten glass, the trough including a first weir, a second weir, and a base extending between weirs. Each weir has a reinforcing portion extending upward from the base towards the tops of the weirs. A width of the base of the trough at a may be less than a top width of the trough. One or more of the top width, width of the base, or angle between an inner surface of the first or second weir and a vertical plane may be constant along a trough length of the trough.

### CROSS-REFERENCE TO RELATED APPLICATIONS

This application claims the benefit of priority of U.S. Provisional Application Ser. No. 62/425,295 filed on Nov. 22, 2016 the contents of which are relied upon and incorporated herein by reference in their entirety as if fully set forth below.

### BACKGROUND

### Field

The present specification generally relates to forming bodies for use in the production of continuous glass ribbons and, more specifically, to forming bodies that mitigate outward bowing of the weirs of the forming bodies.

### Technical Background

The fusion process is one technique for forming glass ribbons. Compared to other processes for forming glass ribbons, such as the float and slot-draw processes, the fusion process produces glass ribbons with a relatively low amount of defects and with surfaces having superior flatness. As a result, the fusion process is widely employed for the production of glass substrates that are used in the manufacture of LED and LCD displays and other substrates that require superior flatness.

In the fusion process molten glass is fed into a forming body (also referred to as an isopipe), which includes forming surfaces that converge at a root. The molten glass evenly flows over the forming surfaces of the forming body and forms a ribbon of flat glass with pristine surfaces that is drawn from the root of the forming body.

The forming body is generally made of refractory materials, such as refractory ceramics, which are able to withstand the relatively high temperatures of the fusion process. However, the mechanical properties of even the most temperature-stable refractory ceramics may degrade over extended periods of time at elevated temperatures, potentially resulting in the degradation of the characteristics of the glass ribbon produced therefrom or even failure of the forming body. Either case may result in disruption of the fusion process, lower product yields, and increased production costs.

Accordingly, a need exists for alternative methods and apparatuses for mitigating the degradation of forming bodies of glass forming apparatuses.

### SUMMARY

In one or more embodiments of the present disclosure, a forming body of a glass forming apparatus is disclosed that comprises a trough for receiving molten glass, the trough comprising a first weir, a second weir spaced apart from the first weir, a base extending between the first weir and the second weir, an inlet end, a distal end opposite the inlet end, and a trough length. The forming body may comprise a first forming surface and a second forming surface, the first forming surface and the second forming surface converging at a root of the forming body. The first and second forming surfaces may, for example, extend from an upper portion of the forming body. The trough may, for example, be positioned in the upper portion of the forming body. The first weir and the second weir may each comprise a top, and a sloped inner surface oriented at an angle with respect to a vertical plane. The first weir and the second weir may each further comprise a reinforcing portion extending upward from the base towards the top. A width of the base of the trough may be less than a top width of the trough such that the trough is trapezoidal in cross-section for at least a portion of the trough length. The top width of the trough may be constant from the inlet end to the distal end of the trough, and the angle between the sloped inner surface and the vertical plane may vary along the at least a portion of the trough length.

The width of the base of the trough may be constant from the inlet end to the distal end of the trough. Alternatively, the width of the base of the trough may vary along at least a portion of the trough length. For example, the width of the base of the trough may increase from the inlet end of the trough towards the distal end of the trough.

The angle between the sloped inner surface and the vertical plane may decrease from the inlet end of the trough towards the distal end of the trough. Alternatively, the angle between the sloped inner surface and the vertical plane may increase from the inlet end of the trough towards the distal end of the trough.

At least a portion of the trough length may extend the entire trough length from the inlet end to the distal end of the trough. Alternatively at least a portion of the trough length may extend from the inlet end of the trough to a distance from 0.25 to 0.5 times the trough length.

In one or more additional embodiments of the disclosure, a forming body of a glass forming apparatus is disclosed that may comprise a trough for receiving molten glass, the trough comprising a first weir, a second weir spaced apart from the first weir, a base extending between the first weir and the second weir, an inlet end, a distal end opposite the inlet end, and a trough length. The forming body may comprise a first forming surface and a second forming surface, the first forming surface and the second forming surface converging at a root of the forming body. The first and second forming surfaces may, for example, extend from an upper portion of the forming body. The trough may, for example, be positioned in the upper portion of the forming body. The first weir and the second weir may each comprise a top having a top thickness, and a sloped inner surface oriented at an angle with respect to a vertical plane. The first weir and the second weir may each further comprise a reinforcing portion extending upward from the base towards the top. A width of the base of the trough may be less than a top width of the trough such that the trough is trapezoidal in cross-section for at least a portion of the trough length. The width of the base of the trough may be constant from the inlet end to the distal end of the trough, and the top width of the trough may vary along the at least a portion of the trough length.

The angle between the sloped inner surface and the vertical plane may be constant from the inlet end to the distal end of the trough. Alternatively, the angle between the sloped inner surface and the vertical plane may vary along at least a portion of the trough length. For example, the angle between the sloped inner surface and the vertical plane may increase from the inlet end towards the distal end of the trough.

The top width of the trough may decrease from the inlet end towards the distal end of the trough. Alternatively, the top width of the trough may increase from the inlet end towards the distal end of the trough.

In still other embodiments of the disclosure, a forming body of a glass forming apparatus is disclosed that may comprise a trough for receiving molten glass, the trough comprising a first weir, a second weir spaced apart from the first weir, a base extending between the first weir and the second weir, an inlet end, a distal end opposite the inlet end, and a trough length. The forming body may comprise a first forming surface and a second forming surface, the first forming surface and the second forming surface converging at a root of the forming body. The first and second forming surfaces may, for example, extend from an upper portion of the forming body. The trough may, for example, be positioned in the upper portion of the forming body. The first weir and the second weir may each comprise a top having a top thickness, and a sloped inner surface oriented at an angle with respect to a vertical plane. The first weir and the second weir may each further comprise a reinforcing portion extending upward from the base towards the top. A width of the base of the trough may be less than a top width of the trough such that the trough is trapezoidal in cross-section for at least a portion of the trough length. The angle between the sloped inner surface and the vertical plane may be constant from the inlet end to the distal end of the trough, and the width of the base of the trough may vary along the at least a portion of the trough length.

The top width of the trough may be constant from the inlet end to the distal end of the trough. Alternatively, the top width of the trough may vary along the at least a portion of the trough length. For example, the top width of the trough may decrease from the inlet end towards the distal end of the trough.

The width of the base of the trough may decrease from the inlet end towards the distal end of the trough. Alternatively, the width of the base of the trough may increase from the inlet end towards the distal end of the trough.

In yet other embodiments of the disclosure, a forming body of a glass forming apparatus may comprise a trough for receiving molten glass, the trough comprising a first weir, a second weir spaced apart from the first weir, a base extending between the first weir and the second weir, an inlet end, a distal end opposite the inlet end, and a trough length. The forming body may comprise a first forming surface and a second forming surface, the first forming surface and the second forming surface converging at a root of the forming body. The first and second forming surfaces may, for example, extend from an upper portion of the forming body. The trough may, for example, be positioned in the upper portion of the forming body. The first weir and the second weir may each comprise a top having a top thickness, and a sloped inner surface oriented at an angle with respect to a vertical plane. The first weir and the second weir may each further comprise a reinforcing portion extending upward from the base towards the top. A width of the base of the trough may be less than a top width of the trough such that the trough is trapezoidal in cross-section for at least a portion of the trough length. The angle between the sloped inner surface and the vertical plane, the top width of the trough, and the width of the base of the trough may vary along the at least a portion of the trough length.

The angle between the sloped inner surface and the vertical plane may increase from the inlet end towards the distal end of the trough. Alternatively, the angle between the sloped inner surface and the vertical plane may decrease from the inlet end towards the distal end of the trough.

The top width of the trough may increase from the inlet end towards the distal end of the trough. In the alternative, the top width of the trough may decrease from the inlet end towards the distal end of the trough.

The width of the base of the trough may increase from the inlet end towards the distal end of the trough. Alternatively, the width of the base of the trough may decrease from the inlet end towards the distal end of the trough.

In another embodiment of the disclosure, a forming body for a glass forming apparatus is disclosed that may comprise a trough for receiving molten glass, the trough comprising a first weir, a second weir spaced apart from the first weir, a base extending between the first weir and the second weir, an inlet end, a distal end opposite the inlet end, and a trough length. The forming body may comprise a first forming surface and a second forming surface, the first forming surface and the second forming surface converging at a root of the forming body. The first and second forming surfaces may, for example, extend from an upper portion of the forming body. The trough may, for example, be positioned in the upper portion of the forming body. The first weir and the second weir may each comprise a top having a top thickness, and a reinforcing portion extending upward from the base towards the top. Each of the reinforcing portions may have a curved inner surface, and the base of the trough may extend between the curved inner surface of the first weir and the curved inner surface of the second weir. A width of the base of the trough may be less than a top width of the trough along at least a portion of a trough length of the trough.

The reinforcing portion of the first weir may extend from the base of the trough to the top of the first weir, and the reinforcing portion of the second weir may extend from the base of the trough to the top of the second weir. The first weir and the second weir may each comprise a vertical portion extending from the reinforcing portion to the top of the first weir and the second weir. The vertical portion may have a vertical inner surface. A ratio of a height of the reinforcing portion to a weir height may decrease from the inlet end towards the distal end of the trough along at least a portion of the trough length.

The curvature of the curved inner surface may vary along at least a portion of the trough length. For example, the curvature of the curved inner surface may decrease along at least a portion of the trough length. A curvature of the curved inner surface may be a concave curvature. The curvature of the curved inner surface may also be a parabolic curvature. A weir thickness at each point along the parabolic curvature of the curved inner surface may be proportional to a bending stress exerted on the first weir or the second weir by molten glass flowing through the trough.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a glass forming apparatus, according to one or more embodiments shown and described herein;

FIG. 2A schematically depicts a conventional forming body for use with a glass forming apparatus;

FIG. 2B schematically depicts a cross-section of the conventional forming body of FIG. 2A taken along section line 2B-2B;

FIG. 2C schematically depicts a top view of the conventional forming body of FIG. 2A;

FIG. 3 is a plot of cross-sectional area (x-axis) versus hydraulic diameter (y-axis) for five flow equivalent rectangular forming bodies having differing trough dimensions but the same mass flow rate over the weirs;

FIG. 4A schematically depicts a side view of a forming body, according to one or more embodiments shown and described herein;

FIG. 4B schematically depicts a top view of the forming body of FIG. 4A, according to one or more embodiments shown and described herein;

FIG. 4C schematically depicts a top view of another embodiment of the forming body of FIG. 4A, according to one or more embodiments shown and described herein;

FIG. 4D schematically depicts a cross-section of the forming body of FIG. 4A taken along section line 4D-4D proximal to an inlet end of the forming body, according to one or more embodiments shown and described herein;

FIG. 4E schematically depicts a cross-section of the forming body of FIG. 4A taken along section line 4E-4E in the middle of the forming body, according to one or more embodiments shown and described herein;

FIG. 4F schematically depicts a cross-section of the forming body of FIG. 4A taken along section line 4F-4F proximal to the distal end of the forming body, according to one or more embodiments shown and described herein;

FIG. 5A schematically depicts a side view of a forming body, according to one or more embodiments shown and described herein;

FIG. 5B schematically depicts a top view of the forming body of FIG. 5A, according to one or more embodiments shown and described herein;

FIG. 5C schematically depicts a top view of another embodiment of the forming body of FIG. 5A, according to one or more embodiments shown and described herein;

FIG. 5D schematically depicts a cross-section of the forming body of FIG. 5A taken along section line 5D-5D proximal to an inlet end of the forming body, according to one or more embodiments shown and described herein;

FIG. 5E schematically depicts a cross-section of the forming body of FIG. 5A taken along section line 5E-5E in the middle of the forming body, according to one or more embodiments shown and described herein;

FIG. 5F schematically depicts a cross-section of the forming body of FIG. 5A taken along section line 5F-5F proximal to the distal end of the forming body, according to one or more embodiments shown and described herein;

FIG. 6A schematically depicts a side view of a forming body, according to one or more embodiments shown and described herein;

FIG. 6B schematically depicts a top view of the forming body of FIG. 4A, according to one or more embodiments shown and described herein;

FIG. 6C schematically depicts a top view of another embodiment of the forming body of FIG. 6A, according to one or more embodiments shown and described herein;

FIG. 6D schematically depicts a cross-section of the forming body of FIG. 6A taken along section line 6D-6D proximal to an inlet end of the forming body, according to one or more embodiments shown and described herein;

FIG. 6E schematically depicts a cross-section of the forming body of FIG. 6A taken along section line 6E-6E in the middle of the forming body, according to one or more embodiments shown and described herein;

FIG. 6F schematically depicts a cross-section of the forming body of FIG. 6A taken along section line 6F-6F proximal to the distal end of the forming body, according to one or more embodiments shown and described herein;

FIG. 7 is a plot of relative bending stress (y-axis) as a function of weir height (x-axis) for the forming body of FIGS. 4A-4F, according to one or more embodiment shown and described herein;

FIG. 8 is a plot of a rate of weir spreading (y-axis) as a function of the relative length (x-axis) of the forming body of FIGS. 5A-5F starting from the distal end of the trough, according to one or more embodiments shown and described herein;

FIG. 9 is a plot of a change in mass flow rate of the forming body of FIGS. 6A-6F (y-axis) as a function of the relative length of the forming body (x-axis) starting from the inlet end of the trough after a period of operation, according to one or more embodiments shown and described herein; and

FIG. 10 is a plot of cross-sectional area (x-axis) versus hydraulic diameter (y-axis) for five flow equivalent rectangular forming bodies having differing trough dimensions but the same mass flow rate over the weirs as well as the cross-sectional area and hydraulic diameter for the forming body of FIGS. 5A-5F, according to one or more embodiments shown and described herein.

### DETAILED DESCRIPTION

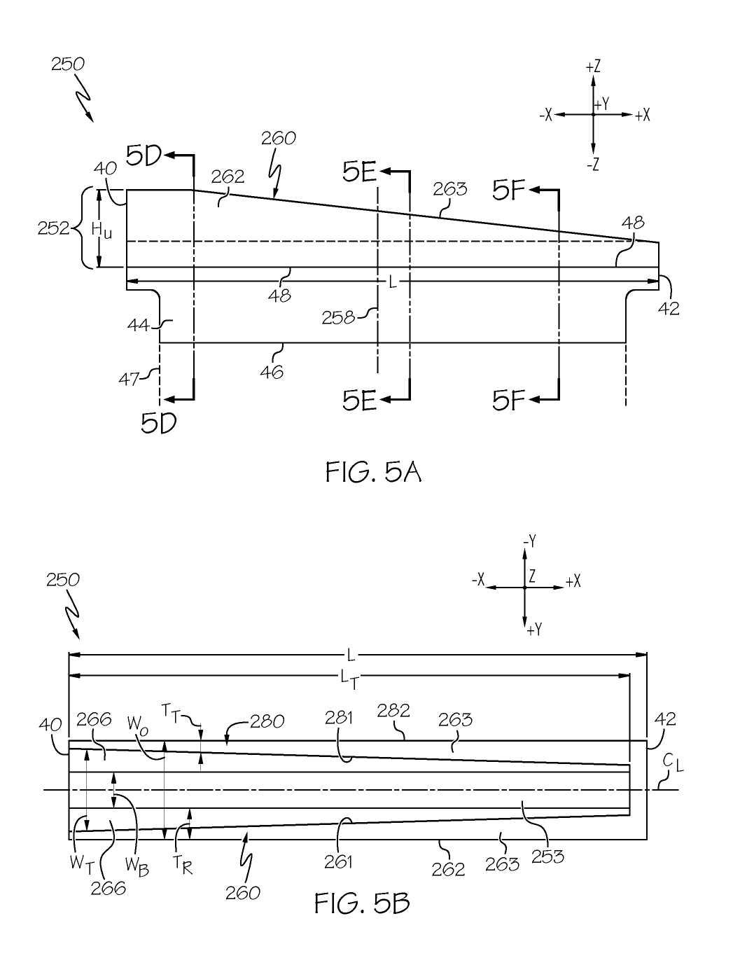

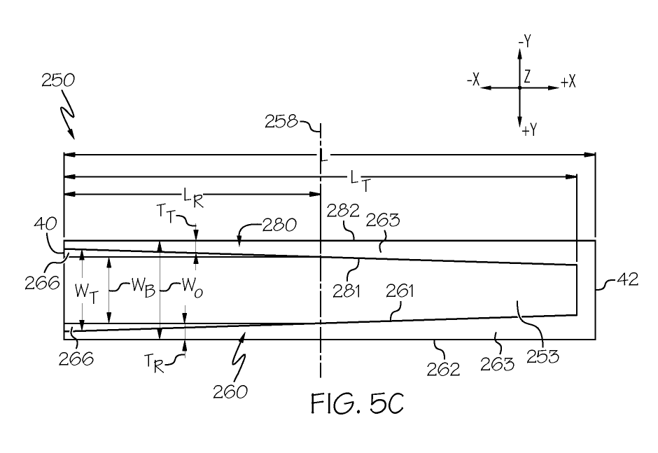

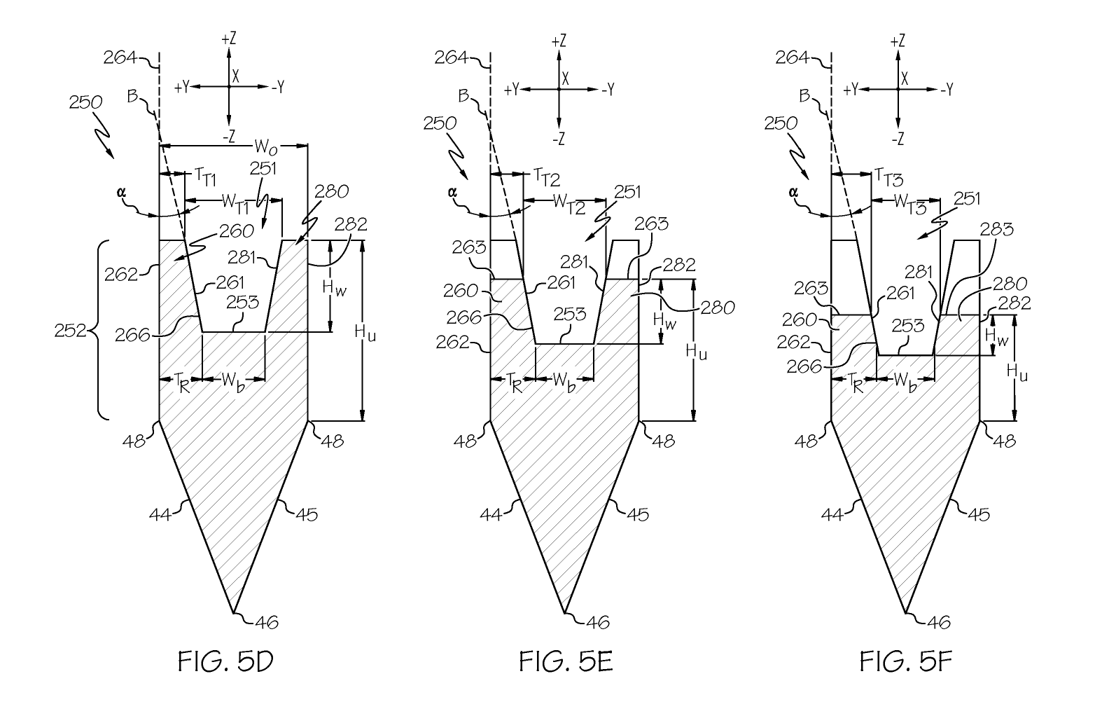

Reference will now be made in detail to embodiments of forming bodies for glass forming apparatuses, examples of which are illustrated in the accompanying drawings. Whenever possible, the same reference numerals will be used throughout the drawings to refer to the same or like parts. One embodiment of a forming body 250 of a glass forming apparatus is schematically depicted in FIGS. 5A-5F. In this embodiment, the forming body 250 includes an upper portion 252 with a first forming surface 44 and a second forming surface 45 extending from the upper portion 252. The first forming surface 44 and the second forming surface 45 converge at a bottom edge (root 46) of the forming body 250. A trough 251 for receiving molten glass is positioned in the upper portion 252 of the forming body 250. The trough 251 includes a first weir 260, a second weir 280 spaced apart from the first weir 260, and a base 253 extending between the first weir 260 and the second weir 280. The trough 251 further includes an inlet end 40, a distal end 42 opposite the inlet end, and a trough length L_{T}. The first weir 260 and the second weir 280 may each include a top 263 and a reinforcing portion 266 extending upward from the base 253 towards the top 263 and a sloped inner surface 261 oriented at an angle α with respect to a vertical plane 264. A width of the base W_{B} of the trough 251 may be less than a top width W_{T} of the trough 251 such that the trough 251 is trapezoidal in cross-section for at least a portion of the trough length L_{T}. The top width W_{T} of the trough 251 may be constant from the inlet end 40 to the distal end 42 of the trough 251, and the angle α between the sloped inner surface and the vertical plane 264 may vary along at least a portion of the trough length L_{T}. Various embodiments of forming bodies for glass forming apparatuses will be further described herein with specific reference to the appended drawings.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that specific orientations be required with any apparatus. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes embodiments having two or more such components, unless the context clearly indicates otherwise.

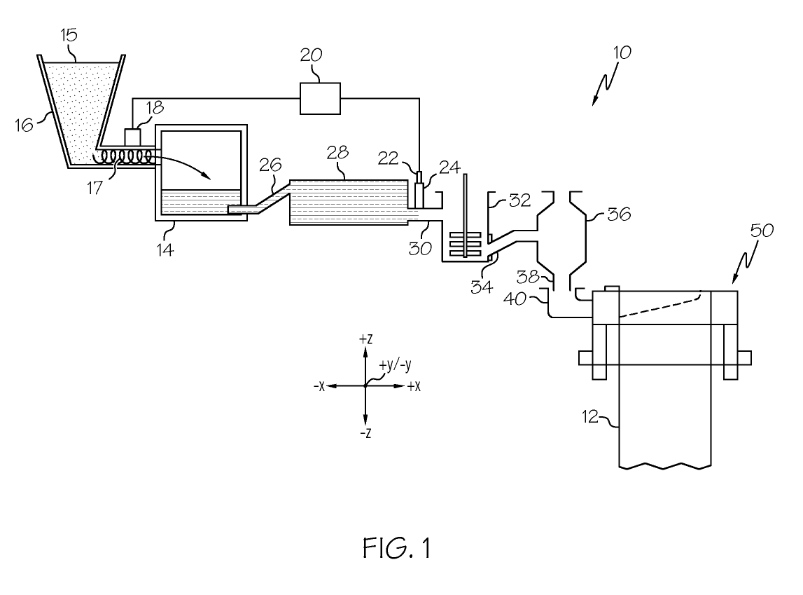

Referring now to FIG. 1, a glass forming apparatus 10 for making glass articles, such as a continuous glass ribbon 12, is schematically depicted. The glass forming apparatus 10 may generally include a melting vessel 14 that receives batch material 15 from a storage bin 16. The batch material 15 can be introduced to the melting vessel 14 by a batch delivery device 17 powered by a motor 18. An optional controller 20 may be provided to activate the motor 18 and a molten glass level probe 22 can be used to measure the glass melt level within a standpipe 24 and communicate the measured information to the controller 20.

The glass forming apparatus 10 can also include a fining vessel 28, such as a fining tube, coupled to the melting vessel 14 by way of a first connecting tube 26. A mixing vessel 32 is coupled to the fining vessel 28 with a second connecting tube 30. A delivery vessel 36 is coupled to the mixing vessel 32 with a delivery conduit 34. As further illustrated, a downcomer 38 is positioned to deliver glass melt from the delivery vessel 36 to an inlet end 40 of a forming body 50. In the embodiments shown and described herein, the forming body 50 is a fusion-forming vessel that may also be referred to as an isopipe.

The melting vessel 14 is typically made from a refractory material, such as refractory (e.g., ceramic) brick. The glass forming apparatus 10 may further include components that are typically made from electrically conductive refractory metals such as, for example, platinum or platinum-containing metals such as platinum-rhodium, platinum-iridium and combinations thereof. Such refractory metals may also include molybdenum, palladium, rhenium, tantalum, titanium, tungsten, ruthenium, osmium, zirconium, and alloys thereof and/or zirconium dioxide. The platinum-containing components can include one or more of the first connecting tube 26, the fining vessel 28, the second connecting tube 30, the standpipe 24, the mixing vessel 32, the delivery conduit 34, the delivery vessel 36, the downcomer 38, and the inlet end 40.

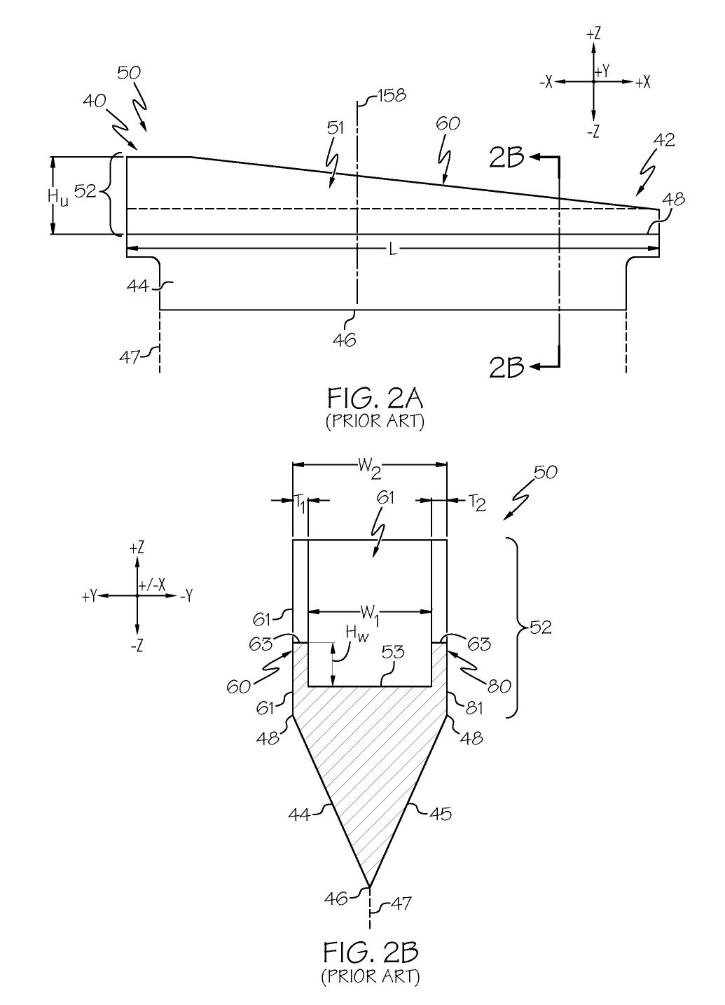

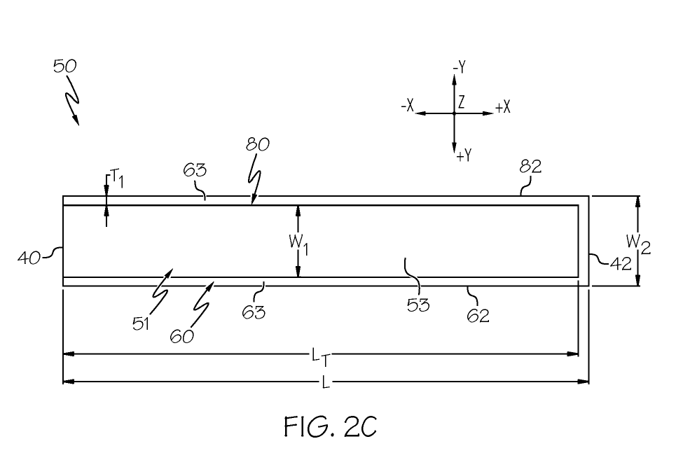

Referring now to FIGS. 2A-2C, a conventional forming body 50 generally includes a trough 51, a first forming surface 44, and a second forming surface 45. The trough 51 is located in an upper portion 52 of the forming body 50 and includes a first weir 60, a second weir 80, and a base 53 extending between the first weir 60 and the second weir 80. The trough 51 may vary in depth (i.e., weir height H_{W}) as a function of length L along the forming body 50. The first forming surface 44 and the second forming surface 45 extend from the upper portion 52 of the forming body 50 in a vertically downward direction (i.e., the −Z direction of the coordinate axes depicted in the figures) and converge towards one another, joining at a lower (bottom) edge of the forming body 50, which may also be referred to as the root 46. Accordingly, it should be understood that the first forming surface 44 and the second forming surface 45 may, in some embodiments, form an inverted isosceles (or equilateral) triangle extending from the upper portion 52 of the forming body 50 with the root 46 forming the lower-most vertex of the triangle in the downstream direction. A draw plane 47 generally bisects the root 46 in the +/−Y directions of the coordinate axes depicted in the figures and extends in the vertically downward direction (i.e., the −Z direction) and in the +/−X directions from the inlet end 40 to the distal end 42 of the forming body 50.

Referring now to FIGS. 1-2C, in operation, batch material 15, specifically batch material for forming glass, is fed from the storage bin 16 into the melting vessel 14 with the batch delivery device 17. The batch material 15 is melted into molten glass in the melting vessel 14. The molten glass passes from the melting vessel 14 into the fining vessel 28 through the first connecting tube 26. Dissolved gasses, which may result in glass defects, are removed from the molten glass in the fining vessel 28. The molten glass then passes from the fining vessel 28 into the mixing vessel 32 through the second connecting tube 30. The mixing vessel 32 homogenizes the molten glass, such as by stirring, and the homogenized molten glass passes through the delivery conduit 34 to the delivery vessel 36. The delivery vessel 36 discharges the homogenized molten glass through downcomer 38 and into the inlet end 40 of the forming body 50, which in turn passes the homogenized molten glass into the trough 51 of the forming body 50 toward the distal end 42 of the forming body 50.

The homogenized molten glass fills the trough 51 of the forming body 50 and ultimately overflows, flowing over the first weir 60 and second weir 80 of the upper portion 52 of the forming body 50 along the length L_{T} (FIG. 2C) of the trough 51 and then in the vertically downward direction. The homogenized molten glass flows from the upper portion 52 of the forming body 50 and onto the first forming surface 44 and the second forming surface 45. Streams of homogenized molten glass flowing over the first forming surface 44 and the second forming surface 45 join and fuse together at the root 46, forming a glass ribbon 12 that is drawn on the draw plane 47 in the downstream direction by pulling rolls (not shown). The glass ribbon 12 may be further processed downstream of the forming body 50 such as by segmenting the glass ribbon 12 into discrete glass sheets, rolling the glass ribbon 12 upon itself, and/or applying one or more coatings to the glass ribbon 12.

The forming body 50 is typically formed from refractory ceramic materials that are chemically compatible with the molten glass and capable of withstanding the high temperatures associated with the fusion forming process, although in further embodiments, portions of the forming body, or the entire forming body may be formed of other materials, for example metallic materials. Typical ceramic refractory materials from which the forming body can be formed include, without limitation, zircon (e.g., zirconium silicate), low creep zircon, silicon carbide, xenotime, and/or alumina based refractory ceramics. The mass of the molten glass flowing into the trough 51 of the forming body 50 exerts an outward pressure on the weirs 60, 80. This pressure, combined with the elevated temperature creep of the refractory ceramic materials that the forming body 50 is made from, can cause the weirs 60, 80 to bow progressively outward (i.e., in the +/−Y directions of the coordinate axes depicted in FIGS. 2A and 2B) over the course of a glass drawing campaign, which may span a period of several years.

The outward bowing, which may be non-uniform along the length L of the forming body 50, may be most pronounced in the first ⅓ of the length L of the forming body 50 from the inlet end 40, where the trough 51 is deepest. The outward bowing of the weirs may significantly alter the glass distribution within the trough 51, reducing glass flow over the weirs 60, 80 where the bowing is most pronounced, and increasing glass flow over the weirs 60, 80 where the bowing is less pronounced. This causes undesirable thickness and width variations in the resultant glass ribbon 12 (FIG. 1), which in turn may lead to process inefficiencies as glass ribbon that is out of specification is discarded. As the bowing progresses with time, use of the forming body 50 may be discontinued and the glass forming apparatus rebuilt due to the degradation in glass quality from the outward bowing.

Additionally, certain types of glass may require processing at very high temperatures (e.g., greater than 1300° C.), and these high temperatures may accelerate the creep of the material from which the forming body 50 is made. This acceleration of the creep may negatively impact the long-term dimensional stability of the forming body 50, which may reduce the life span of the forming body 50. A conventional solution to mitigating creep has been to construct the forming body 50 from a material with enhanced thermal stability, which may substantially increase the capital cost of the forming body 50. Also, as demand for fusion formed glass increases, larger forming bodies 50 may be utilized to generate greater mass flow rates of the glass and increase throughput of the fusion forming process, as well as increasing the width of the resultant glass ribbon. Increasing the mass flow rate of the glass from the forming body 50 may require increasing the volume of the forming body 50, which, in turn, places additional hydraulic stress on the weirs, and may further enhance outward bowing of the weirs. Constructing larger forming bodies 50 may require larger blanks of refractory materials, and increases the cost of manufacturing the forming bodies 50 and the glass sheets formed with such forming bodies.

FIGS. 2A-2C generally depict a conventional forming body 50 having a trough 51 defined by a first weir 60, a second weir 80 spaced apart from the first weir 60, and a base 53 extending between the first weir 60 and the second weir 80. The forming body 50 is depicted in FIGS. 2A-2C before being used in the forming apparatus 10 and before any bowing of the weirs has occurred. The forming body 50 has an outer width W₂ measured from a first outer surface 62 of the first weir 60 to a second outer surface 82 of the second weir 80. The outer width W₂ of the forming body 50 is constant from the first forming surface 44 and second forming surface 45 to the tops 63 of the first and second weirs 60, 80 and from the inlet end 40 to the distal end 42 of the trough 51. The outer surface 62 of the first weir 60, the first forming surface 44, the second forming surface 45, and the outer surface 82 of the second weir 80 define a three-dimensional outer shape having the outer width W₂ and a height profile in which an upper portion height H_{U} of the forming body 50, measured from a junction 48 between the first forming surface 44 and the first outer surface 62 or between the second forming surface 45 and the second outer surface 82, gradually decreases from the inlet end 40 to the distal end 42 of the forming body 50.

In the forming body 50 depicted in FIGS. 2A-2C, the trough 51 has a rectangular cross-section extending from the inlet end 40 to the distal end 42 of the forming body 50. In its initial state (i.e., prior to use of the forming body 50 in a glass forming apparatus), an inner width W₁ of the rectangular trough 51 is constant from the base 53 of the trough 51 to the top 63 of the first weir 60 and the second weir 80 and from the inlet end 40 to the distal end 42 of the trough 51. That is, the cross section of the trough 51 is rectangular in vertical cross section. Unless otherwise specified in this disclosure, the vertical cross section of a feature, such as the trough 51, refers to a cross-section taken along a reference plane that is parallel to the Y-Z plane of the coordinate axes depicted in FIG. 2B and a vertical cross sectional area refers to the area of the feature in the vertical cross section. The first weir 60 and the second weir 80 are vertical (i.e., parallel with the X-Z plane of the coordinate axes depicted in FIG. 2B) and parallel to each other. The first weir 60 is rectangular in vertical cross-section and has a constant weir thickness T₁ from the base 53 of the trough 51 to the top 63 of the first weir 60 and from the inlet end 40 to the distal end 42 of the trough 51. The second weir 80 is also rectangular in vertical cross-section and has a constant weir thickness T₂ from the base 53 of the trough 51 to the top 63 of the second weir 80 and from the inlet end 40 to the distal end 42 of the trough 51. A vertical cross sectional area of the trough 51 at any point along the length L of the forming body 50 may be calculated as the inner width W₁ multiplied by the weir height H_{w} of the trough 51. As used in this disclosure, the weir height H_{W} refers to the height of the first or second weir 60, 80 at any point along the trough length L_{T} and may generally be equal to or less than an inlet weir height at the inlet end 40 of the trough 51. Additionally, a hydraulic diameter may be defined for the forming body 50 at any point along the trough length L_{T} as the cross-sectional area of the forming body 50 at that point divided by the wetted perimeter of the forming body 50 at that point. For a trough 51 having a rectangular vertical cross-section, the cross-sectional area is equal to the weir height H_{W} multiplied by the inner width W₁. The wetted perimeter may be two times the weir height H_{W} plus the inner width W₁. Thus, the hydraulic diameter of a rectangular forming body 50 at any point along the trough length L_{T} may be defined as (H_{W}*W₁)/(2*H_{W}+W₁).

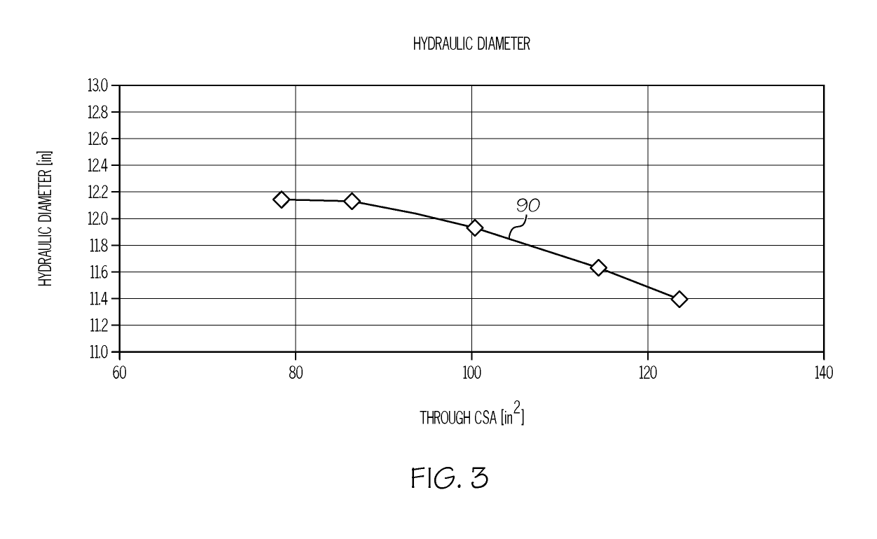

Referring to FIG. 3, the hydraulic diameter of the trough 51 is plotted against the vertical cross-sectional area of the trough 51 for several forming bodies 50 having rectangular-shaped troughs 51. The forming bodies 50 represented in FIG. 3 have identical mass flow rates of glass over the first and second weirs 60, 80 but different cross-sectional areas defined by different inner widths W₁ and different inlet weir heights, which is the weir height H_{w} measured at the inlet end of the forming body 50. The vertical cross-sectional areas and hydraulic diameters were determined for each rectangular forming body 50 at a constant longitudinal position (i.e., +/−X direction) along the length L of the forming body 50 from the inlet end 40 to the distal end 42 of the forming body 50. A trendline fit to the vertical cross-sectional area versus hydraulic diameter data produces a flow equivalency curve 90 for the flow equivalent rectangular forming bodies 50 having rectangular troughs 51 at a specific glass mass flow rate. From left to right along the flow equivalency curve 90, the inner width W₁ of the trough 51 decreases and the weir height H_{w} increases. As the vertical cross-sectional area increases, the hydraulic diameter decreases. A forming body having a vertical cross-sectional area and a hydraulic diameter that lie on the flow equivalency curve 90 in FIG. 3, irrespective of the cross-sectional shape, has the same mass flow rate of glass over the first and second weirs 60, 80 as the forming bodies 50 used to develop the flow equivalency curve 90 of FIG. 3, provided the vertical cross-sectional areas and hydraulic diameters are determined at the same longitudinal position along the trough length L_{T}. Different flow equivalency curves 90 may be developed for different target glass mass flow rates.

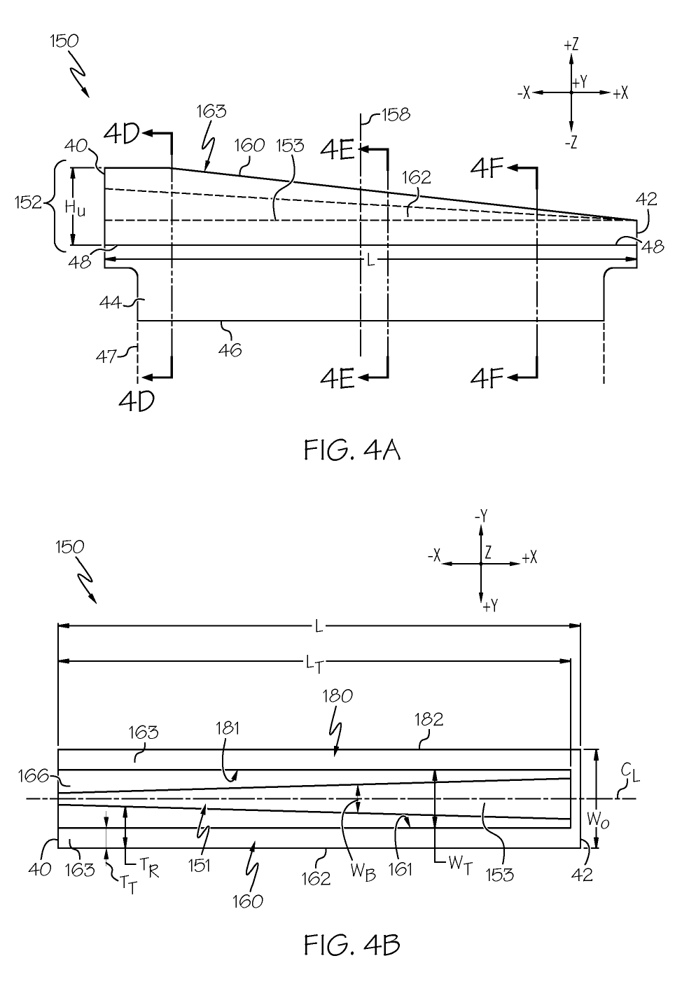

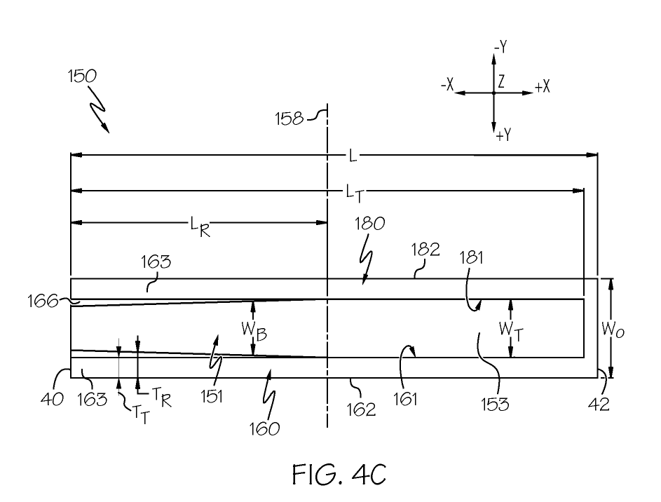

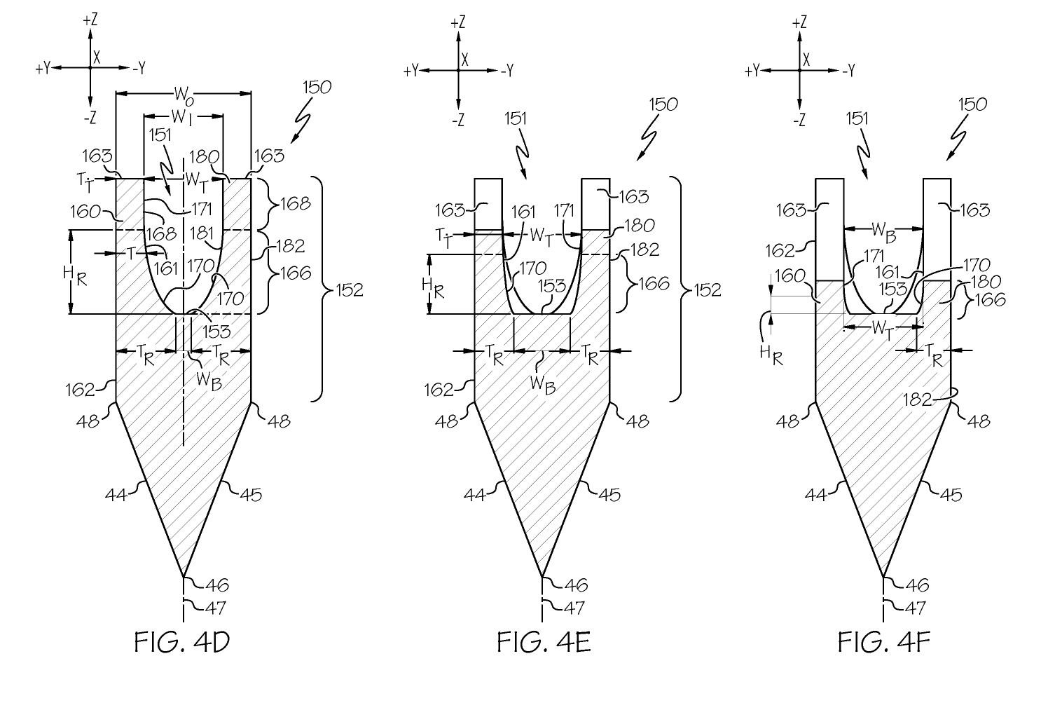

Embodiments of forming bodies subsequently described in this disclosure will be compared to a “flow equivalent rectangular forming body.” As used in this disclosure, the phrase “flow equivalent rectangular forming body” refers to the forming body 50, which was described above, having a rectangular shaped trough 51, and a mass flow rate of glass over the first and second weirs 60, 80 and outer shapes that are the same as the mass flow rate and outer shapes of forming bodies 150, 250 (FIGS. 4A-6F) discussed subsequently in this disclosure. The properties of the flow equivalent rectangular forming body 50 discussed herein are specified prior to use of the flow equivalent rectangular forming body 50 in the glass forming apparatus 10 (i.e., before any outward bowing of the weirs). The first weir 60 and the second weir 80 of the flow equivalent rectangular forming body 50 are vertical and parallel to each other and have weir thicknesses T₁, T₂ that are the same as the top thickness T_{T} at the inlet end 40 of the troughs 151, 251 of the first weirs 160, 260 and second weirs 180, 280 of the forming bodies 150, 250 (FIGS. 4A-6F) discussed subsequently in this disclosure. The trough 51 of the flow equivalent rectangular forming body 50 has a rectangular vertical cross-section, and/or the first weir 60 and the second weir 80 of the flow equivalent rectangular forming body 50 have rectangular vertical cross-sections. The outer shape, which is defined by the first outer surface 62, first forming surface 40, second forming surface 42, and second outer surface 82 of the flow equivalent rectangular forming body 50 is the same as an outer shape of the forming bodies 150, 250 discussed subsequently in this disclosure.

The embodiments of the forming bodies subsequently described in this disclosure mitigate the on-set of outward bowing of the weirs of the forming body compared to a flow equivalent rectangular forming body, thereby prolonging the service life of the forming body and stabilizing the dimensional characteristics of the glass ribbon 12 (FIG. 1) formed therefrom. Additionally, the embodiments of the forming bodies subsequently described herein may provide flow equivalency relative to conventional flow equivalent rectangular forming bodies 50, while simultaneously maintaining an outer shape of the forming body (prior to use in the glass forming apparatus 10) that is the same as the outer shape of the flow equivalent rectangular forming body 50 (prior to use in the glass forming apparatus 10) to maintain consistent properties of the glass ribbon 12 formed therewith.

For each of the embodiments of the forming bodies subsequently described in this disclosure, each of the weirs may be reinforced by adding material to the bottom portion of the weirs proximal to the base. Adding material to the bottom portion of the weirs may change the cross-sectional area and/or the flow dynamics of the forming bodies, which may result in changes to the mass flow rate of the molten glass over the weirs of the forming body. Therefore, adjustments to the thickness T_{T} at the tops of the first and second weirs, the depth of the trough, other geometric parameters, or combinations of these may be made to provide the forming bodies with equivalent mass flow rates over the weirs compared to flow equivalent rectangular forming bodies 50 having the same exterior shape and dimensions. Reinforcing the bottom portions of the weirs may provide better resistance to weir spreading, and adjustments to the geometry of the trough to maintain flow equivalence may avoid compromising the flow characteristics of the molten glass. Further, reinforcing the bottom portion of the weirs may reduce weir spreading without relying on compressive forces applied to the weirs to mitigate bowing.

Referring now to FIGS. 4A-4F, a forming body 150 is schematically depicted that includes a trough 151, the first forming surface 44, and the second forming surface 45. The dimensions in FIGS. 4A-4F are exaggerated for purposes of illustration. The trough 151 is located in an upper portion 152 of the forming body 150 and comprises a base 153 extending between a first weir 160 and a second weir 180. The trough 151 becomes shallower in depth along a trough length L_{T} of the trough 151 from the inlet end 40 to the distal end 42 of the forming body 150. The first forming surface 44 and the second forming surface 45 extend from the upper portion 152 of the forming body 150 in a vertically downward direction (i.e., the −Z direction of the coordinate axes depicted in the figures) and converge towards one another, joining at the root 46 of the forming body 150. Accordingly, it should be understood that the first forming surface 44 and the second forming surface 45 may, in some embodiments, form an inverted triangle (isosceles or equilateral) extending from the upper portion 152 of the forming body 150 with the root 46 forming the lower-most vertex of the triangle in the vertically downward direction. A draw plane 47 generally bisects the root 46 in the +/−Y directions of the coordinate axes depicted in the figures and extends in the vertically downward direction and in the +/−X directions from the inlet end 40 to the distal end 42 of the forming body 150.

Referring to FIGS. 4D-4F, the first weir 160 includes a first inner surface 161, a first outer surface 162, and a top 163 extending between the first inner surface 161 and the first outer surface 162. The first inner surface 161 extends from the base 153 of the trough 151 to the top 163 of the first weir 160, and the first outer surface 162 extends generally vertically (i.e., the +/−Z direction) between the first forming surface 44 and the top 163 of the first weir 160. The upper portion height H_{U} of the first outer surface 162 from the first forming surface 44 to the top 163 of the first weir 160 decreases from the inlet end 40 to the distal end 42 of the forming body 150 to define the height profile of the upper portion 152 of the forming body 150. The first outer surface 162 has a shape defined from the first forming surface 44 to the top 163 of the first weir 160 and from the inlet end 40 to the distal end 42 of the forming body 150. The second outer surface 182 has a shape defined from the second forming surface 45 to the top 163 of the second weir 180 and from the inlet end 40 to the distal end 42 of the forming body 150. The shape of the first outer surface 162 is the same as the shape of the second outer surface 182, and the first outer surface 162 and the second outer surface 182 are parallel and vertical relative to the X-Z plane defined by the coordinate axes in FIGS. 4A-4F. The shape of the first outer surface 162 and the shape of the second outer surface 182 of the forming body 150 may be the same as the first outer surface 62 (FIG. 2B) and the second outer surface 82 (FIG. 2B) of the flow equivalent rectangular forming body 50 (FIG. 2B), in which the first outer surface 62 (FIG. 2B) and the second outer surface 82 (FIG. 2B) that are parallel and vertical relative to the X-Z plane defined by the coordinate axes in FIGS. 2A-2B.

The first weir 160 includes a reinforced portion 166 proximal to the base 153 and extending upward (i.e., in the +Z direction) towards the top 163 of the first weir 160. The first weir 160 has a weir thickness T, which is measured in the +/−Y direction of the coordinate axes in FIGS. 4D-F from the first inner surface 161 to the first outer surface 162. In the reinforced portion 166, a maximum reinforced thickness T_{R} of the first weir 160 measured proximal to the base 153 of the trough 151 may be greater than a top thickness T_{T} measured at the top 163 of the first weir 160. In one or more embodiments, the weir thickness T may decrease from the maximum reinforced thickness T_{R} at the base 153 of the trough 151 upward in the +Z direction to the top thickness T_{T} proximal to the top 163 of the first weir 160. In one or more embodiments, the first weir 160 may have a vertical portion 168 extending from the top 163 of the first weir 160 downward to the reinforced portion 166 of the first weir 160. The weir thickness T may be constant in the vertical portion 168 of the first weir 160 and may be the same as the top thickness T_{T} of the first weir 160.

A reinforced height H_{R} of the first weir 160 is defined as a vertical distance from the base 153 of the trough 151 to an upper end of the reinforced portion 166. The upper end of the reinforced portion 166 may be the top 163 of the first weir 160 or, alternatively, a transition point 169 between the reinforced portion 166 and the vertical portion 168. The weir thickness T may gradually decrease from the maximum reinforced thickness T_{R} at the base 153 of the trough 151 to the upper end of the reinforced portion 166. For example, in one or more embodiments, the upper end of the reinforced portion 166 may be the top 163 of the first weir 160 so that the reinforced height H_{R} may be equal to the weir height H_{W} and the weir thickness T may gradually decrease from the maximum reinforced thickness T_{R} at the base 153 of the trough 151 to the top thickness T_{T} at the top 163 of the first weir 160. Alternatively, in other embodiments, the upper end of the reinforced portion 166 may correspond to the transition point 169 between the reinforced portion 166 and the vertical portion 168, which is proximal to the top 163 of the first weir 160. The reinforced height H_{R} may be less than the weir height H_{W} and the weir thickness T may gradually decrease from the maximum reinforced thickness T_{R} at the base 153 of the trough 151 to the transition point 169, at which the weir thickness T may be equal to the top thickness T_{T}, and then remain constant from the transition point 169 to the top 163 of the first weir 160.

The reinforced height H_{R} may decrease along the trough length L_{T} of the trough 151 from the inlet end 40 to the distal end 42, as illustrated progressively from FIG. 4D to FIG. 4E and then to FIG. 4F. The trough length L_{T} may be defined as a longitudinal distance from the inlet end 40 of the forming body 150 to the end of the trough 151 at the distal end 42 of the forming body 150, at which point the weir height H_{W} decreases to zero. In one or more embodiments, the reinforced height H_{R} may decrease in proportion to the decrease in the weir height H_{W} along the length L_{T} of the trough 151. A reinforced height ratio H_{R}/H_{W} is defined as a ratio of the reinforced height H_{R} to the weir height H_{W}. In embodiments, the reinforced height ratio H_{R}/H_{W} may be constant along the length L_{T} of the trough 151. Alternatively, in one or more embodiments, the reinforced height H_{R} may decrease faster per unit length than the weir height H_{W} along the trough length L_{T} from the inlet end 40 to the distal end 42 of the trough 151. That is, a rate of decrease of the reinforced height H_{R} per unit length of the trough 151 may be greater than a rate that the weir height H_{W} decreases per unit length of the trough 151 along the trough length L_{T} from the inlet end 40 to the distal end 42 of the trough 151. In these embodiments, the reinforced height ratio H_{R}/H_{W} may decrease from the inlet end 40 to the distal end 42 of the trough 151.

Referring to FIGS. 4B and 4D-4F, in one or more embodiments, the maximum reinforced thickness T_{R} at the base 151 of the trough 150 may be constant from the inlet end 40 to the distal end 42 of the trough 151. In other embodiments, the maximum reinforced thickness T_{R} at the base 151 of the trough 150 may decrease from the inlet end 40 to the distal end 42 of the trough 151. In one or more embodiments, an average weir thickness T_{A}, which is an average of the weir thickness T of the first weir 160 from the base 153 to the top 163 of the first weir 160, may decrease along the trough length L_{T} from the inlet end 40 to the distal end 42 of the trough 151.

Referring to FIG. 4C, as previously described, the maximum bending stress on the first and second weirs 160, 180, which is caused by the pressure from the molten glass against the first and second weirs 160, 180, may occur within the first ⅓ of the trough length L_{T} of the trough 151 from the inlet end 40 of the trough 151 towards the distal end 42. Therefore, the reinforcing portion 166 may provide more benefit in countering bending stress and reducing weir spreading in the first ⅓ of the trough length L_{T} starting at the inlet end 40 of the trough 151 as compared to the distal end 42 of the trough 151, where the trough 151 is shallower and, hence, the pressure or stress exerted by the molten glass is lower. That is, as the weir height H_{W} decreases from the inlet end 40 to the distal end 42 of the trough 151, the trough 151 is shallower and the bending stresses exerted on the first weir 160 and the second weir 180 may decrease towards the distal end 42 of the trough 151. In one or more embodiments, the maximum reinforced thickness T_{R} and the reinforced height ratio H_{R}/H_{W} may both decrease along the trough length L_{T} from the inlet end 40 to the distal end 42 of the trough 151, as depicted in FIG. 4C and as illustrated progressively from FIG. 4D to FIG. 4E and then to FIG. 4F.

For example, in embodiments, the reinforced portion 166 may extend partially along the length L of the trough 151 from the inlet end 40 to the distal end 42, as illustrated in FIG. 4C. In one or more embodiments, the reinforced portion 166 may extend from the inlet end 40 of the trough 151 to a longitudinal midpoint 158 of the trough 151. That is, in embodiments, the reinforced portion 166 may extend from the inlet end 40 of the trough 151 and may have a reinforced length L_{R} that is less than the trough length L_{T}. A reinforced length ratio L_{R}/L_{T} may be less than or equal to 0.9 in some embodiments, less than or equal to 0.7 in other embodiments, less than or equal to 0.5 in still other embodiments, or even less than or equal to 0.4 in still other embodiments. In one or more embodiments, the reinforced length ratio L_{R}/L_{T} may be from 0.2 to 0.75, from 0.2 to 0.5, from 0.2 to 0.4, from 0.25 to 0.75, from 0.25 to 0.5, or from 0.25 to 0.4.

Alternatively, in one or more embodiments, the reinforced length L_{R} may be the same as the trough length L_{T} as shown in FIG. 4B. In one or more embodiments, the longitudinal midpoint 158 of the trough 151 corresponds to a longitudinal position at which L_{R}/L_{T} is equal to 0.5. In other words, the longitudinal midpoint 158 corresponds to a longitudinal position that is half the trough length L_{T} from the inlet end 40 to the distal end 42 of the trough 251.

Referring to FIGS. 4D-4F, the inner surface 161 may include a curved section 170 along the reinforced portion 166 of the first weir 160. In embodiments in which the reinforced height H_{R} of the reinforced portion 166 is less than the weir height H_{W}, the inner surface 161 may also have a vertical section 171 extending from the transition point 169 to the top 163 of the first weir 160. Alternatively, the curved section 170 may extend from the base 153 of the trough 151 to the top 163 of the first weir 160. In one or more embodiments, the curvature of the curved section 170 may be concave. The curvature of the curved section 170 may be a parabolic curvature, circular curvature, elliptical curvature, or other curved shape or combinations thereof (i.e., a compound curvature). It should be noted that, in the drawings appended hereto, the curvatures of the curved sections 170 of the first weir 160 and the second weir 180 are exaggerated for purposes of illustration.

The curvature of the curved section 170 may change along the trough length L_{T} from the inlet end 40 to the distal end 42 of the trough 151. In one or more embodiments, the curvature (e.g., the radius of curvature) of the curved section 170 may decrease along the trough length L_{T} from the inlet end 40 to the distal end 42 of the trough 151. For example, in embodiments having a generally circular curvature, a radius of curvature of the curved section 170 may be larger at the inlet end 40 of the trough 151 and decrease along the trough length L_{T} towards the distal end 42 of the trough 151.

Still referring to FIGS. 4D-4F, in one or more embodiments, the curvature of the curved section 170 may be a parabolic curvature. In these embodiments, the bending stress on the first weir 160 and the second weir 180 may be modeled using the stress equation for a cantilever beam fixed at one end under uniform load, which is a parabolic equation and is expressed below in the following Equation 1 (Eq. 1):

$$S = \frac{F}{2 Zl} {( l - x )}^{2} \text{:} \qquad Eq , 1$$

In Eq. 1, S is the stress on the cantilever beam, F is the uniform load, l is the length of the cantilever beam, x is the distance along the cantilever beam; and Z in relation to Equation 1 only (i.e., not to be confused with the Z axis referenced throughout the specification) is the section modulus of the cross-section of the beam and is equal to I/z where I is the moment of inertia of the beam and z is the distance from a neutral axis to the extreme edge of the beam. In one or more embodiments, the curvature of the curved section 170 may be modeled to counteract the bending stress exerted by a uniform load of molten glass exerting pressure against the inner surface 161 of the first weir 160. The weir thickness T of the first weir 160 at each point along the curvature of the inner surface 161 of the first weir 160 may be proportional to the bending stresses exerted on the first weir 160 by molten glass flowing through the trough 151 at each of the points along the inner surface 161. In these embodiments, the curvature of the curved section 170 may conform to a section of the curve defined by the general parabolic equation of the following Equation 2:

$$y = \frac{{z}^{2}}{2} \text{:} \qquad Eq , 2$$

In Eq. 2, y represents the +/−Y position of a point on the curved section 170 and z represents the +/−Z position of a point on the curved section 170. The curvature of the curved section 170 strengthens the first weir 160 and second weir 180 at the base 153 of the trough 151 mitigating the outward bowing of the weirs and improving the dimensional stability of the first and second weirs 160, 180. It should be understood that the same strengthening of the first and second weirs 160, 180 leading to mitigation of outward bowing and improvement of dimensional stability of the weirs may be achieved with other curvatures.

Referring to FIGS. 4D-4F, the second weir 180 includes a second inner surface 181, a second outer surface 182, and a top 163 extending between the second inner surface 181 and the second outer surface 182. The second weir 180, the second inner surface 181, and the second outer surface 182 may each exhibit one or more of the characteristics previously described above in relation to the first weir 160, first inner surface 161, and the first outer surface 162, respectively. In one or more embodiments, the second weir 180 may be a mirror image of the first weir 160 and may have the same dimensions as the first weir 160 along the trough length L_{T}.

In the embodiments of the forming body 150 schematically depicted in FIGS. 4A-4F, the trough 151 formed by the first weir 160, the second weir 180, and the base 153 has an outer width W_{O} measured from the first outer surface 162 to the second outer surface 182 that is constant along the trough length L_{T} longitudinally (i.e., in the +/−X direction) from the inlet end 40 to the distal end 42 of the trough 151 and vertically (i.e., the +/−Z direction) along the height H_{U} of the upper portion 152 from the junction 48 of the upper portion 152 with the first and second forming surfaces 44, 45 to the tops 163 of the first weir 160 and the second weir 180. The trough 151 has a top inner width W_{T} measured between the first inner surface 161 of the first weir 160 and the second inner surface 181 of the second weir 180 at the tops 163 of the first and second weirs 160, 180. The top inner width W_{T} may be constant along the trough length L_{T} from the inlet end 40 to the distal end 42 of the trough 151.

Still referring to FIGS. 4D-4F, the base 153 may be a flat surface that is generally perpendicular to the first outer surface 162 and the second outer surface 182 (i.e., generally perpendicular to the X-Z plane defined by the coordinate axes in FIGS. 4A-4F). A bottom inner width of the trough 151 may be the same as the width of the base W_{B} measured between the reinforced portions 166 of the first weir 160 and the second weir 180. In one or more embodiments, the width of the base W_{B} at the inlet end 40 of the trough 151 may be less than the width of the base W_{B} at the distal end 42 of the trough 151. That is, in one or more embodiments, the width of the base W_{B} of the trough 151 may increase along the trough length L_{T} from the inlet end 40 to the distal end 42 of the trough 151. In one or more embodiments, the reinforced portions 166 of the first weir 160 and the second weir 180 may meet at a centerline C_{L} (FIG. 4B) of the trough 151 so that the bottom of the trough 151 is continuously curved from the first weir 160 to the second weir 180, and the width of the base W_{B} may be zero.

In one or more embodiments, an average inner width of the trough 151, which is the average of the width of the trough 151 taken from the base 153 to the tops 163 of the first weir 160 and the second weir 180, may be constant along the trough length L_{T} from the inlet end 40 to the distal end 42 of the trough 151. In other embodiments, the average inner width of the trough 151 at the inlet end 40 may be greater than the average inner width of the trough 151 at the distal end 42 of the trough 151. That is, in one or more embodiments, the average inner width of the trough 151 may increase along the trough length L_{T} from the inlet end 40 to the distal end 42 of the trough 151.

The embodiments of the forming body 150 schematically depicted in FIGS. 4A-4F which have curved reinforced portions 166 in the first and second weirs 160, 180, may have an outer shape and a mass flow rate over the first and second weirs 160, 180 that is the same as the outer shape and mass flow rate of a flow equivalent rectangular forming body 50 (FIGS. 2A-2C), while mitigating the outward bowing of the weirs that occurs in the flow equivalent rectangular forming body 50. As previously described in this disclosure, the outer shape of the forming body 150 is defined by the first outer surface 162, the first forming surface 44, the second forming surface 45, and the second outer surface 182 of the forming body 150. In the embodiments described herein, the length L and the outer width W_{O} of the forming body 150 may be the same as the length L and the outer width W₂ (FIG. 2B) of the flow equivalent rectangular forming body 50. Additionally, the upper portion height H_{U} of the forming body 150 at each point along the length of the forming body 150 from the inlet end 40 to the distal end 42 of the trough 151 may be the same as the upper portion height H_{U} of the flow equivalent rectangular forming body 50 at the same points along the length L of the flow equivalent rectangular forming body 50 from the inlet end 40 to the distal end 42. Maintaining the outer shape of the forming body 150 the same as the outer shape of the flow equivalent rectangular forming body 50 maintains the flow dynamics of the molten glass down the first outer surface 162 and first forming surface 44 to the root 46 and down the second outer surface 182 and second forming surface 45 to the root 46, which may result in a fusion formed glass sheet 12 (FIG. 1) that is the same as the fusion formed glass sheet produced by the flow equivalent rectangular forming body 50, before any bowing of the weirs has occurred. However, the curved sections 170 of the first and second weirs 160, 180 of forming body 150 reinforce the first and second weirs 160, 180 and mitigate bowing of the weirs 160, 180.

Reinforcing the first and second weirs 160, 180 (i.e., by thickening the first and second weirs 160, 180 at the base 153 of the trough 151) to mitigate bowing changes the flow characteristics of the forming body 150. Therefore, reinforcement of the first and second weirs 160, 180 should be done in a manner that maintains flow equivalency when the cross sectional area of the trough 151 is reduced. Reinforcement of the weirs 160, 180 is accomplished without causing the forming body 150 to deviate from the flow equivalency curve developed for a target glass mass flow rate (e.g., such as the flow equivalency curve 90 depicted in FIG. 3) developed for the specific glass mass flow rate. More specifically, to maintain flow equivalence of the forming body 150 with the flow equivalent rectangular forming body 50, certain inner dimensions of the trough 151 may be varied or altered. Introduction of the reinforced portions 166 and the curved sections 170 of the first and second inner surfaces 161, 181 along the reinforced portions 166 reduces the length of the flow path of molten glass from the bottom of the trough 151 (i.e., the base 153 of the trough 151) to the tops 163 of the first and second weirs 160, 180, which may in turn reduce the impedance of the flow of molten glass from the inlet end 40 of the trough 151 to the tops 163 of the first and second weirs 160, 180. A reduction in impedance of the flow of molten glass to the tops 163 of the first and second weirs 160, 180 increases the flow rate of molten glass over the tops 163 of the first and second weirs 160, 180 as compared to the flow equivalent rectangular forming body 50 having the same cross-sectional area. However, to compensate for this change in flow, the cross-sectional area of the trough 151 may be decreased to increase the impedance to flow of the molten glass and thereby reduce the mass flow rate of the molten glass over the first and second weirs 160, 180 to provide the same mass flow rate of molten glass as the flow equivalent rectangular forming body 50.

In embodiments, the vertical cross-sectional area of the trough 151 of the forming body 150 may be decreased by decreasing the weir height H_{W} (i.e., making the trough 151 shallower while maintaining the upper portion height H_{U} the same as the flow equivalent rectangular forming body 50), changing the top thickness T_{T} of the first and second weirs 160, 180, making other geometric changes, or combinations thereof. Thus, the vertical cross-sectional area of the trough 151 is decreased so that a plot of the hydraulic diameter versus the vertical cross-sectional area for the trough 151 of the forming body 150 remains on the flow equivalency curve for the target glass mass flow rate (e.g., such as the flow equivalency curve 90 depicted in FIG. 3) produced for the flow equivalent rectangular forming bodies 50 having the same mass flow rate of molten glass and the same mass flow rate.

The forming body 150 may provide better resistance to weir spreading compared to the flow equivalent rectangular forming bodies 50, while maintaining the molten glass flow characteristics (i.e., mass flow and flow dynamics along the outer surfaces of the forming body 150). The forming body 150 may also provide better resistance to weir spreading without relying on the application of compressive forces to counter act weir spreading. Further, using curved sections 170 along the reinforced portions 166 of the first and second weirs 160, 180 may allow for increased resistance to weir spreading with minimum material added to the first and second weir 160, 180.

In one or more embodiments, a forming body 150 of a glass forming apparatus 10 comprises an upper portion 152; a first forming surface 44 and a second forming surface 45 extending from the upper portion 152, the first forming surface 44 and the second forming surface 45 converging at a root 46 of the forming body 150; and a trough 151 for receiving molten glass positioned in the upper portion 152 of the forming body 150, the trough 151 comprising a first weir 160, a second weir 180 spaced apart from the first weir 160, and a base 153 extending between the first weir 160 and the second weir 180, the trough 151 further comprising an inlet end 40 and a distal end 42. The first weir 160 and the second weir 180 each comprise a top 163 having a top thickness T_{T}, and a reinforcing portion 166 extending upward from the base 153 towards the top 163. Each of the reinforcing portions 166 has a curved inner surface 161, 181. The base 153 of the trough 151 extends between the curved inner surface 161 of the first weir 160 and the curved inner surface 181 of the second weir 180. A width of the base W_{B} of the trough 151 is less than a top width W_{T} of the trough 151 along at least a portion of the longitudinal length (i.e., trough length L_{T}) the trough 151.

In embodiments, the reinforcing portion 166 of the first weir 160 may extend from the base 153 of the trough 151 to the top 163 of the first weir 160 and the reinforcing portion 166 of the second weir 180 may extend from the base 153 of the trough 151 to the top 163 of the second weir 180. In some embodiments, the first weir 160 and the second weir 180 may each comprise a vertical portion 168 extending from the reinforcing portion 166 to the top 163 of the first weir 160 and the second weir 180. The vertical portion 168 has a vertical inner surface 171. In one or more embodiments, a ratio of a height H_{R} of the reinforcing portion 166 to a weir height H_{W} may decrease from the inlet end 40 towards the distal end 42 of the trough 151 along at least a portion of the longitudinal length (i.e., trough length L_{T}) of the trough 151.

In one or more embodiments, a curvature of the curved inner surface 161 may be a concave curvature. Alternatively, in other embodiments, the curvature of the curved inner surface 161 may vary along at least a portion of the longitudinal length of the trough 151. In yet other embodiments, the curvature of the curved inner surface may decrease along at least a portion of the longitudinal length of the trough 151. In some embodiments, the curvature of the curved inner surface 160 may be a parabolic curvature. In some of these embodiments, the weir thickness at each point along the parabolic curvature of the curved inner surfaces 161, 181 may be proportional to the bending stress exerted on the first weir 160 or the second weir 180 by molten glass flowing through the trough 151.

Referring now to FIGS. 5A-5F, an alternative embodiment of a forming body 250 is schematically depicted. As with the embodiments of the forming body 150 depicted in FIGS. 4A-4F, the embodiments of the forming body 250 depicted in FIGS. 5A-5F are constructed to mitigate the outward bowing of the weirs while maintaining the molten glass flow characteristics relative to a flow equivalent rectangular forming body. The dimensions in FIGS. 5A-5F are exaggerated for purposes of illustration. In one or more embodiments, the forming body 250 includes a trough 251 with a trapezoidal-shaped vertical cross-section. The forming body 250 includes the trough 251, the first forming surface 44, and the second forming surface 45. The trough 251 is positioned in an upper portion 252 of the forming body 250 and comprises a first weir 260, a second weir 280, and a base 253 extending between the first weir 260 and the second weir 280. The trough 251 becomes shallower in depth along the trough length L_{T} from the inlet end 40 to the distal end 42 of the trough 251. The first forming surface 44 and the second forming surface 45 extend from the upper portion 252 of the forming body 250 in a vertically downward direction (i.e., the −Z direction of the coordinate axes depicted in the figures) and converge towards one another, joining at the root 46 of the forming body 250. Accordingly, it should be understood that the first forming surface 44 and the second forming surface 45 may, in some embodiments, form an inverted triangle (isosceles or equilateral) extending from the upper portion 252 of the forming body 250 with the root 46 forming the lower-most vertex of the triangle in the vertically downward direction. A draw plane 47 generally bisects the root 46 in the +/−Y directions of the coordinate axes depicted in the figures and extends in the vertically downward direction and in the +/−X directions from the inlet end 40 to the distal end 42 of the forming body 250.

Referring to FIGS. 5D-5F, the first weir 260 includes a first inner surface 261, a first outer surface 262, and a top 263 extending between the first inner surface 261 and the first outer surface 262. The second weir 280 includes a second inner surface 281, a second outer surface 282, and a top 263 extending between the second inner surface 281 and the second outer surface 282. For ease of illustration, the shape of the first weir 260 and the second weir 280 will be described in reference to the first weir 260, with the understanding that the second weir 280 may be a mirror image of the first weir 260 and may have any of the characteristics of the first weir 260, which are subsequently described in this disclosure.

The first inner surface 261 of the first weir 260 extends from the base 253 of the trough 251 to the top 263 of the first weir 260, and the first outer surface 262 extends vertically (i.e., the +/−Z direction) between the first forming surface 44 and the top 263 of the first weir 260. The upper portion height H_{U} of the first outer surface 262 from the first forming surface 44 to the top 263 of the first weir 260 decreases from the inlet end 40 to the distal end 42 of the forming body 250 to define a height profile of the upper portion 252 of the forming body 250. The first outer surface 262 has an outer shape defined from the first forming surface 44 to the top 263 of the first weir 260 and from the inlet end 40 to the distal end 42 of the forming body 250. The second outer surface 282 has a shape defined from the second forming surface 45 to the top 263 of the second weir 280 and from the inlet end 40 to the distal end 42 of the forming body 150. The shape of the first outer surface 262 is the same as the outer shape of the second outer surface 282, and the first outer surface 262 and the second outer surface 282 are parallel and vertical relative to the X-Z plane defined by the coordinate axes in FIGS. 5A-5F. The outer shape of the first outer surface 262 of the forming body 250 may be the same as the outer shape of the first outer surface 62 (FIGS. 2A-2B) of the flow equivalent rectangular forming body 50 (FIG. 2A-2B), in which the first outer surface 62 (FIG. 2B) and the second outer surface 82 (FIG. 2B) that are parallel and vertical relative to the X-Z plane defined by the coordinate axes in FIGS. 2A-2B.

The first weir 260 includes a reinforced portion 266 extending from the base 253 upward (i.e., in the +Z direction) towards the top 263 of the first weir 260. The weir thickness T is the thickness of the first weir 260 measured in the +/−Y direction of the coordinate axis in FIGS. 5A-5F from the first inner surface 261 to the first outer surface 262. A maximum reinforced thickness T_{R} of the first weir 260, which is the weir thickness T measured at a +/−Z position proximal to the base 253 of the trough 251, may be greater than a top thickness T_{T}, which is the weir thickness T measured at the top 263 of the first weir 260. In one or more embodiments, the weir thickness T may gradually decrease from the maximum reinforced thickness T_{R} at the base 253 of the trough 251 upward in the +Z direction along the first weir 260 to the top thickness T_{T} proximal to the top 263 of the first weir 260.

The first inner surface 261 may slope away from the first outer surface 262 (i.e., in the −Y direction) from the top 263 of the first weir 260 downward (i.e., in the −Z direction) to the base 253 of the trough 251. The slope of the first inner surface 261 at any point along the trough length L_{T} is defined as the slope of a line B, which is a line extending in the Y-Z plane along the first inner surface 261 from the base 253 of the trough 251 to the top 263 of the first weir 260. The slope of line B is defined as the absolute value of ΔZ/ΔY; in which ΔZ is the change in the +/−Z direction between two points on line B and ΔY is the change in the +/−Y direction between the same two points on line B. The slope of the first inner surface 261 may be constant along the trough length L_{T} from the base 253 of the trough 251 towards the top 263 of the first weir 260 at each point along the trough length L_{T}, which is consistent with line B being a single straight line. For example, in some embodiments, the first inner surface 261 may be planar, and line B may have a constant slope along the trough length L_{T} (i.e., in the +/−X direction) from the inlet end 40 to the distal end 42 of the trough 251.

Alternatively, the slope of the first inner surface 261 may vary along the trough length L_{T} from the inlet end 40 to the distal end 42 of the trough 251. In one or more embodiments, the slope of the first inner surface 261 proximal to the inlet end 40 of the trough 251 may be less than the slope of the first inner surface 261 proximal to the distal end 42 of the trough 251. For example, in some embodiments, the slope of the first inner surface 261 may increase along the trough length L_{T} from the inlet end 40 to the distal end 42 of the trough 251. A first inner surface 261 having a slope that varies along the trough length L_{T} may be non-planar and may twist along the trough length L_{T} from the inlet end 40 to the distal end 42 of the trough 251. Increasing the slope of the first inner surface 261 along the trough length L_{T} towards the distal end 42 reduces the reinforcement of the first weir 260 proximate to the distal end 42 of the trough 251, in which region the bending stresses of the molten glass on the first weir 260 may be substantially less compared to the bending stresses proximal to the inlet end 40 of the trough 251. Reinforcement of the first weir 260 and the second weir 280 may be less impactful at the distal end 42 of the trough 251 due to the reduced bending stresses.

The slope of the first inner surface 261 may also be characterized by a slope angle α, which is an angle in the Y-Z plane between the inner surface 261 and a vertical plane parallel to the first outer surface 262. The slope angle α previously described is the same as the angle formed between the vertical plane 264 and line B described above as a line extending in the Y-Z plane along the first inner surface 261 from the base 253 of the trough 251 to the top 263 of the first weir 260. The slope angle α may be greater than zero along at least a portion of the inner surface 261 from the inlet end 40 to the distal end 42 of the trough 251. In one or more embodiments, the slope angle α may be constant along the trough length L_{T} from the inlet end 40 to the distal end 42 of the trough 251. Alternatively, in other embodiments, the slope angle α at the inlet end 40 of the trough 251 may be greater than the slope angle α at the distal end 42 of the trough 251. For example, in embodiments, the slope angle α may decrease along the trough length L_{T} from the inlet end 40 to the distal end 42 of the trough 251. Alternatively, in other embodiments, the slope angle α may increase along the trough length L_{T} from the inlet end 40 to the distal end 42 of the trough 251.

Still referring to FIGS. 5D-5F, the maximum reinforced thickness T_{R} of the first weir 260, which is measured proximal to the base 253, may be constant along the trough length L_{T} from the inlet end 40 to the distal end 42 of the trough 251. In one or more embodiments, the top thickness T_{T} of the first weir 260 may increase along the trough length L_{T} from the inlet end 40 to the distal end 42 of the trough 251. FIGS. 5D-5F illustrate vertical cross-sections of the forming body 250 at the inlet end 40, in the middle, and at the distal end 42 of the trough 251. The first top thickness T_{T1} at the inlet end 40 of the trough 251 may be less than a second top thickness T_{T2} in the middle of the trough, and the second top thickness T_{T2} may be less than a third top thickness T_{T3} at the distal end 42 of the trough 251. In one or more embodiments, the first top thickness T_{T1} (FIG. 5D) at the inlet end 40 of the trough 251 may be less than the third top thickness T_{T3} (FIG. 5F) at the distal end 42 of the trough 251.

With the maximum reinforced thickness T_{R} maintained constant along the trough length L_{T}, increasing the top thickness T_{T} of the first weir 260 along the trough length L_{T} may result in an average weir thickness that increases along the trough length L_{T} from the inlet end 40 to the distal end 42 of the trough 251. The average weir thickness is the average thickness of the first weir 260 from the base 253 to the top 263 of the first weir 260. In one or more embodiments, the slope of the first inner surface 261 of the first weir 260 may increase along the trough length L_{T} so that the average weir thickness may be constant or may decrease along the trough length L_{T} from the inlet end 40 to the distal end 42 of the trough 251 with increasing top thickness T_{T}.

Referring to FIG. 5C, as previously described, the maximum bending stress on the first weir 260 and the second weir 280, which is caused by the pressure from the molten glass against the first and second weirs 260, 280, may occur within the first ⅓ of the trough length L_{T} from the inlet end 40 towards the distal end 42 of the trough 251. Therefore, the maximum reinforced thickness T_{R} of the first weir 160 may be more effective in reducing weir spreading in the first ⅓ of the trough length L_{T} starting at the inlet end 40 of the trough 251 as compared to the distal end 42 of the trough 251, where the trough 251 is shallower and, hence, the pressure or stress exerted by the molten glass is lower at the top of the trough. In one or more embodiments, the maximum reinforced thickness T_{R} may decrease along the trough length L_{T} from the inlet end 40 to the distal end 42 of the trough 251. In one or more embodiments, the slope of the first inner surface 261 may increase along the trough length L_{T} from the inlet end 40 to the distal end 42 of the trough 251.

In one or more embodiments, the maximum reinforced thickness T_{R}, and thus the reinforced portion 266 of the first weir 260 and second weir 280, may extend only partially along the trough length L_{T} from the inlet end 40 to the distal end 42, as illustrated in FIG. 5C. For example, in some embodiments, the maximum reinforced thickness T_{R} may extend from the inlet end 40 of the trough 251 to a longitudinal midpoint 258 of the trough 251. That is, in embodiments, the maximum reinforced thickness T_{R} may extend from the inlet end 40 of the trough 251 and may have a reinforced length L_{R} that is less than the trough length L_{T}. A reinforced length ratio L_{R}/L_{T} may be less than or equal to 0.9 in some embodiments, less than or equal to 0.7 in other embodiments, less than or equal to 0.5 in still other embodiments, or even less than or equal to 0.4 in still other embodiments. In one or more embodiments, the reinforced length ratio L_{R}/L_{T} may be from 0.2 to 0.75, from 0.2 to 0.5, from 0.2 to 0.4, from 0.25 to 0.75, from 0.25 to 0.5, or from 0.25 to 0.4.

Alternatively, in one or more embodiments, the reinforced length L_{R} may be the same as the trough length L_{T} as shown in FIG. 5B. In one or more embodiments, the longitudinal midpoint 258 of the trough 251 corresponds to a longitudinal position at which L_{R}/L_{T} is equal to 0.5. In other words, the longitudinal midpoint 258 corresponds to a longitudinal position that is half the trough length L_{T} from the inlet end 40 to the distal end 42 of the trough 251.

As illustrated in FIGS. 5D-5F, the second weir 280, the second inner surface 281, and the second outer surface 282 may each exhibit one or more of the characteristics previously described above in relation to the first weir 260, first inner surface 261, and the first outer surface 262, respectively. In one or more embodiments, the second weir 280 may be a mirror image of the first weir 260 and may have the same dimensions as the first weir 260. For the second weir 280, the second inner surface 281 may slope away from the second outer surface in a +Y direction (i.e., a direction opposite the slope of the first inner surface 261) so that the maximum reinforced thickness T_{R} of the second weir 280 measured at the base 253 is greater than the top thickness T_{T} at the top of the second weir 280.

In embodiments of the forming body 250 schematically depicted in FIGS. 5A-5F, the trough 251 formed by the first inner surface 261, the second inner surface 281, and the base 253 may have a trapezoidal-shaped cross-section. The trough 251 formed by the first weir 260, the second weir 280, and the base 253 may have an outer width W_{O} measured from the first outer surface 262 to the second outer surface 282 that is constant along the trough length L_{T} of the trough 151 longitudinally (i.e., in the +/−X direction) from the inlet end 40 to the distal end 42 of the trough 251 and vertically (i.e., the +/−Z direction) along the upper portion height H_{E} of the upper portion 252 from the junction 48 of the upper portion 252 with the first and second forming surfaces 44, 45 to the tops 263 of the first weir 260 and the second weir 280, respectively. The trough 251 may have a top inner width W_{T} measured between the first inner surface 261 and the second inner surface 281 proximal to the tops 263 of the first weir 260 and the second weir 280. The top inner width W_{T} may decrease along the trough length L_{T} from the inlet end 40 to the distal end 42 of the trough 251.

In one or more embodiments, the base 253 may be a flat surface that is generally perpendicular to the first outer surface 262 and the second outer surface 282 (i.e., generally perpendicular to the X-Z plane defined by the coordinate axes in FIGS. 5A-5F). As previously described, the width of the base W_{B} is a width of the base 253 measured between the first inner surface 261 and the second inner surface 281, and represents the inner width of the trough 251 at the bottom of the trough 251. In one or more embodiments, the width of the base W_{B} of the trough 251 may be constant along the trough length L_{T} from the inlet end 40 to the distal end 42 of the trough 251. Alternatively, in other embodiments, the slope of the first inner surface 261 and the second inner surface 281 may increase from the inlet end 40 to the distal end 42 of the trough 251, which may cause the width of the base W_{B} to increase along the trough length L_{T} from the inlet end 40 to the distal end 42 of the trough 251.

In one or more embodiments, an average inner width of the trough 251, which is an average of the width of the trough 251 taken from the base 253 of the trough 251 to the tops 263 of the first weir 260 and the second weir 280, may decrease along the trough length L_{T} from the inlet end 40 to the distal end 42 of the trough 251. That is, in embodiments, the average inner width of the trough 251 at the inlet end 40 may be greater than the average inner width of the trough 251 at the distal end 42 of the trough 251. Alternatively, in other embodiments, the slope of the first inner surface 261 and the second inner surface 281 may increase from the inlet end 40 to the distal end 42 of the trough 251, which may cause the average inner width of the trough 251 to remain constant or increase along the trough length L_{T} from the inlet end 40 to the distal end 42 of the trough 251. As previously described, the depth (i.e., weir height H_{W}) of the trough 251 may decrease along the trough length L_{T} from the inlet end 40 to the distal end 42 of the trough 251.

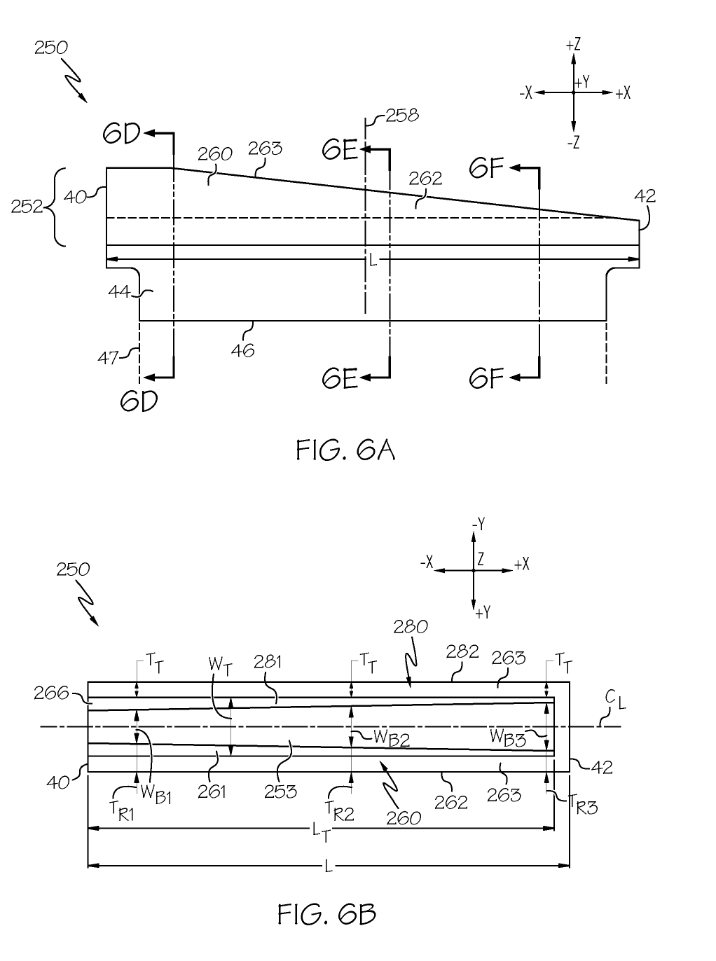

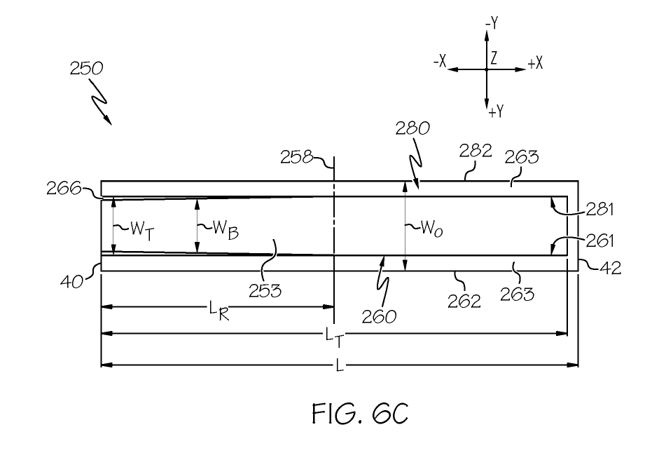

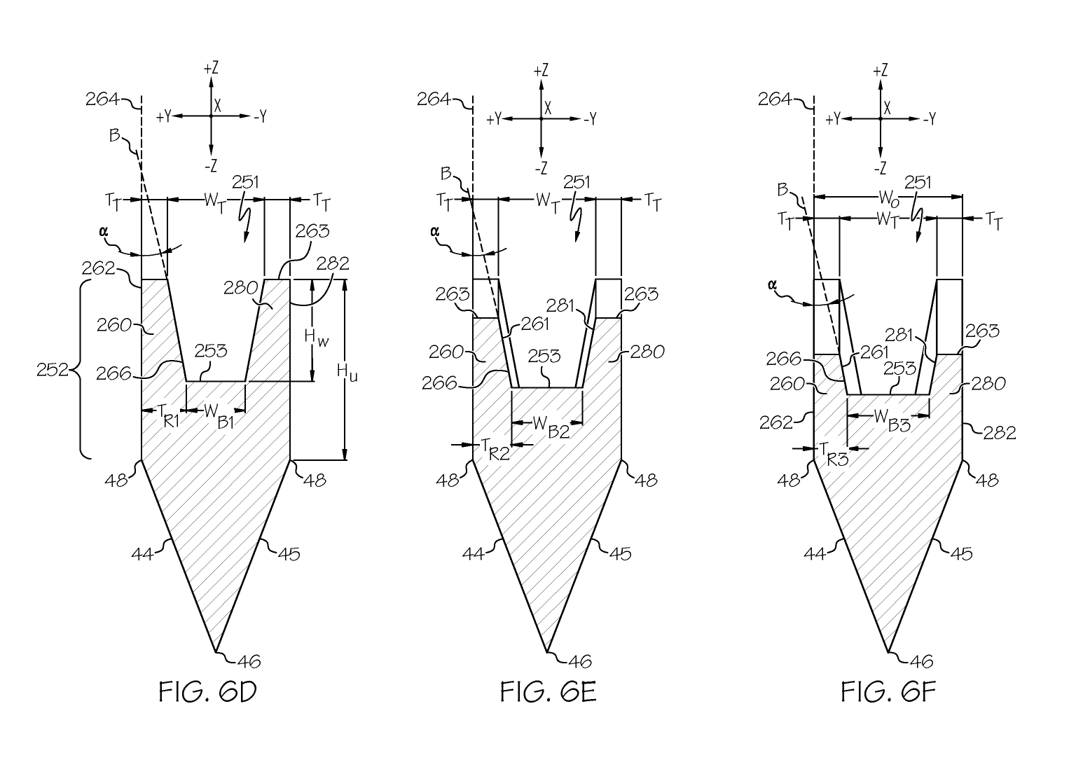

Referring now to FIGS. 6A-6F, an alternative embodiment of forming body 250, having a trapezoidal-shaped vertical cross-section, is schematically depicted. As with the previously described embodiments of forming body 150 depicted in FIGS. 4A-4F and forming body 250 depicted in FIGS. 5A-5F, the embodiments of forming body 250 depicted in FIGS. 6A-6F are constructed to mitigate the outward bowing of the first and second weirs 260, 280 while maintaining the molten glass flow characteristics relative to a flow equivalent rectangular forming body 50. The dimensions in FIGS. 6A-6F are exaggerated for purposes of illustration. The forming body 250 may include the trough 251, the first forming surface 44, and the second forming surface 45. The trough 251 includes the first weir 260, the second weir 280, and the base 253 extending between the first weir 260 and the second weir 280. The trough 251 becomes shallower in depth along a trough length L_{T} of the trough 251 from the inlet end 40 to the distal end 42 of the trough 251. The first forming surface 44 and the second forming surface 45 extend from the upper portion 252 of the forming body 250 in a vertically downward direction (i.e., the −Z direction of the coordinate axes depicted in FIG. 6A) and converge toward one another, joining at the root 46 of the forming body 250.

Referring to FIGS. 6D-6F, the first weir 260 includes the first inner surface 261, the first outer surface 262, and the top 263 extending between the first inner surface 261 and the first outer surface 262. The second weir 280 includes the second inner surface 281, the second outer surface 282, and the top 263 extending between the second inner surface 281 and the second outer surface 282. For ease of illustration, the shape of the first weir 260 and the second weir 280 will be described in reference to the first weir 260, with the understanding that the second weir 280 may be a mirror image of the first weir 260 and may have any of the characteristics of the first weir 260, which are subsequently described in this disclosure.

As noted herein, the first inner surface 261 of the first weir 260 extends from the base 253 of the trough 251 to the top 263 of the first weir 260. The maximum reinforced thickness T_{R} of the first weir 260, which is the weir thickness T measured at a +/−Z position proximal to the base 253 of the trough 251, may be greater than a top thickness T_{T}, which is the weir thickness T measured at the top 263 of the first weir 260. The weir thickness T may gradually decrease from the maximum reinforced thickness T_{R} at the base 253 of the trough 251 to the top thickness T_{T} proximal to the top 263 of the first weir 260.

The first inner surface 261 may slope away from the first outer surface 262 in the −Y direction from the top 263 of the first weir 260 to the base 253 of the trough 251. The slope (i.e., the absolute value of ΔZ/ΔY, which defines the slope of line B extending in the Y-Z plane along the first inner surface 261 from the base 253 of the trough 251 to the top 263 of the first weir 260) of the first inner surface 261 may be constant along the trough length L_{T} from the base 253 of the trough 251 towards the top 263 of the first weir 260 at each point along the trough length L_{T}. In one or more embodiments, the first inner surface 261 may be planar, and line B may have a constant slope along the trough length L_{T} from the inlet end 40 to the distal end 42 of the trough 251. Alternatively, in other embodiments, the slope of the first inner surface 261 may vary along the trough length L_{T} from the inlet end 40 to the distal end 42 of the trough 251.

In one or more embodiments, a slope of the first inner surface 261 proximal to the inlet end 40 of the trough 251 may be less than a slope of the first inner surface 261 at the distal end 42 of the trough 251. For example, in embodiments, the slope of the first inner surface 261 may increase along the trough length L_{T} from the inlet end 40 to the distal end 42 of the trough 251. A first inner surface 261 having a slope that varies along the trough length L_{T} may be non-planar and may twist along the trough length L_{T} from the inlet end 40 to the distal end 42 of the trough 251. Increasing the slope of the first inner surface 261 towards the distal end 42 of the trough 251 reduces the reinforcement of the first weir 260 proximate to the distal end 42 of the trough 251, in which region the bending stresses of the molten glass on the first weir 260 may be substantially less than the bending stresses proximal to the inlet end 40 of the trough 251.

The slope of the first inner surface 261 may also be characterized by the slope angle α, which was previously described herein as the angle between the first inner surface 261 and a vertical plane 264 parallel to the first outer surface 262. The slope angle α may be greater than zero along at least a portion of the inner surface 261 from the inlet end 40 to the distal end 42 of the trough 251. In one or more embodiments, the slope angle α may be constant along the trough length L_{T} from the inlet end 40 to the distal end 42 of the trough 251. Alternatively, the slope angle α at the inlet end 40 of the trough 251 may be greater than the slope angle α at the distal end 42 of the trough 251. For example, in embodiments, the slope angle α may decrease along the trough length L_{T} from the inlet end 40 to the distal end 42 of the trough 251. Alternatively, in other embodiments, the slope angle α may increase along the trough length L_{T} from the inlet end 40 to the distal end 42 of the trough 251.

Still referring to FIGS. 6D-6F, the top thickness T_{T} of the first weir 260 proximal to the top 253 may be constant along the trough length L_{T} from the inlet end 40 to the distal end 42 of the trough 251. In one or more embodiments, the maximum reinforced thickness T_{R} of the first weir 260, which is measured proximal to the base 253, may increase along the trough length L_{T} from the inlet end 40 to the distal end 42 of the trough 251. FIGS. 6D-6F illustrate vertical cross-sections of the forming body 250 at the inlet end 40, in the middle, and at the distal end 42 of the trough 251. The first reinforced thickness T_{R1} proximal to the inlet end 40 of the trough 251 may be less than a second reinforced thickness T_{R2} in the middle of the trough, and the second reinforced thickness T_{R2} may be less than the third reinforced thickness T_{R3} proximal to the distal end 42 of the trough 251. In one or more embodiments, the first reinforced thickness T_{R1} (FIG. 6D) at the inlet end 40 of the trough 251 may be less than a third reinforced thickness T_{R3} (FIG. 6F) at the distal end 42 of the trough 251. In one or more embodiments, the top thickness T_{T} of the first weir 260 proximate to the inlet end 40 of the trough 251 may be less than the weir thickness T (FIG. 2B) of the flow equivalent rectangular forming body 50 (FIG. 2A-2B).

With the top thickness T_{T} maintained constant along the trough length L_{T}, decreasing the maximum reinforced thickness T_{R} of the first weir 260 along the trough length L_{T} may result in an average weir thickness that decreases along the trough length L_{T} from the inlet end 40 to distal end 42 of the trough 251. As previously described, the average weir thickness is the average thickness of the first weir 260 taken from the base 253 to the top 263 of the first weir 260. In one or more embodiments, the slope of the first inner surface 261 of the first weir 260 may be increased along the trough length L_{T}.

As shown in FIGS. 6B and 6D-6F, with the top thickness T_{T} of the first weir 260 and the second weir 280 remaining constant along the trough 251, the top inner width W_{T} of the trough 251 may also remain constant along the trough length L_{T} from the inlet end 40 to the distal end 42 of the trough 251. The width of the base W_{B} of the trough 251 may increase along the trough length L_{T} from the inlet end 40 to the distal end 42 of the trough 251. As illustrated in FIGS. 6D-6F, in embodiments, a first width of the base W_{B1} proximal to the inlet end 40 of the trough 251 may be less than a second width of the base W_{B2} at the middle of the trough 251, and the second width of the base W_{B2} at the middle of the trough 251 may be less than a third width of the base W_{B3} proximal to the distal end 42 of the trough 251. In embodiments, the slope angle α between the first inner surface 261 and the vertical plane 261 parallel with the first outer surface 262 (i.e., the slope of the first inner surface 261) may be constant along the trough length L_{T} from the inlet end 40 to the distal end 42 of the trough 251. Alternatively, in other embodiments, the slope angle α between the first inner surface 261 and the vertical plane 261 parallel with the first outer surface 262 may vary from the inlet end 40 to the distal end 42 of the trough 251. In some of these embodiments, the slope angle α between the first inner surface 261 and the vertical plane 261 parallel with the first outer surface 262 may increase from the inlet end 40 to the distal end 42 of the trough 251, which may cause the width of the base W_{B} to increase at a greater rate along the trough length L_{T} from the inlet end 40 to the distal end 42 of the trough 251 as compared to embodiments having a constant slope angle α or slope of the first inner surface 261.

In one or more embodiments, an average inner width of the trough 251 (i.e., the average of the width of the trough 251 taken from the base 253 to the tops 263 of the first and second weirs 260, 280) may increase along the trough length L_{T} from the inlet end 40 to the distal end 42 of the trough 251. In one or more embodiments, the average inner width of the trough 251 at the inlet end 40 may be less than the average inner width of the trough 251 at the distal end 42 of the trough 251.

In one or more embodiments of the forming bodies 250 schematically depicted in FIGS. 5A-6F, the top width W_{T} of the trough 251 may be constant from the inlet end 40 to the distal end 42 of the trough 251 and the angle α between the sloped inner surface 261 and the vertical plane 264 may vary along at least a portion of the trough length L_{T}. The angle α between the sloped inner surface 261 and the vertical plane 264 may decrease from the inlet end 40 towards the distal end 42 of the trough 251. Alternatively, the angle α between the sloped inner surface 261 and the vertical plane 264 may increase from the inlet end 40 towards the distal end 42 of the trough 251. In these embodiments, the width of the base W_{B} of the trough 251 may be constant from the inlet end 40 to the distal end 42 of the trough 251. Alternatively, the width of the base W_{B} of the trough 251 may vary along at least a portion of the trough length L_{T}. In some embodiments, the width of the base W_{B} of the trough 251 may increase from the inlet end 40 towards the distal end 42 of the trough 251.

In one or more other embodiments of the forming bodies 250 schematically depicted in FIGS. 5A-6F, the width of the base W_{B} of the trough 251 may be constant from the inlet end 40 to the distal end 42 of the trough 251 and the top width W_{T} of the trough 251 may vary along at least a portion of the trough length L_{T}. The top width W_{T} of the trough 251 may decrease from the inlet end 40 towards the distal end 42 of the trough 251. Alternatively, top width W_{T} of the trough 251 may increase from the inlet end 40 towards the distal end 42 of the trough 251. In these embodiments, the angle α between the sloped inner surface 261 and the vertical plane 264 may be greater than zero and constant from the inlet end 40 to the distal end 42 of the trough 251. Alternatively, the angle α between the sloped inner surface 261 and the vertical plane 264 may vary along at least a portion of the trough length L_{T}. In some embodiments, the angle α between the sloped inner surface 261 and the vertical plane 264 may increase from the inlet end 40 towards the distal end 42 of the trough 251.

In one or more additional embodiments of the forming bodies 250 schematically depicted in FIGS. 5A-6F, the angle α between the sloped inner surface 261 and the vertical plane 264 of the trough 251 may be greater than zero and constant from the inlet end 40 to the distal end 42 of the trough 251 and the width of the base W_{B} of the trough 251 may vary along at least a portion of the trough length L_{T}. The width of the base W_{B} of the trough 251 may decrease from the inlet end 40 towards the distal end 42 of the trough 251. Alternatively, the width of the base W_{B} of the trough 251 may increase from the inlet end 40 towards the distal end 42 of the trough 251. In these embodiments, the top width W_{T} of the trough 251 may be constant from the inlet end 40 to the distal end 42 of the trough 251. Alternatively, the top width W_{T} of the trough 251 may vary along at least a portion of the trough length L_{T}. In some embodiments, the top width W_{T} of the trough 251 may decrease from the inlet end 40 towards the distal end 42 of the trough 251.

In one or more embodiments, the angle α between the sloped inner surface 261 and the vertical plane 264, the top width W_{T}, and the width of the base W_{B} of the trough 251 may vary along at least a portion of the trough length L_{T} from the inlet end 40 towards the distal end 42 of the trough 251. In some embodiments, the angle α between the sloped inner surface 261 and the vertical plane 264 may increase from the inlet end 40 towards the distal end 42. Alternatively, in embodiments, the angle α between the sloped inner surface 261 and the vertical plane 264 may decrease from the inlet end 40 towards the distal end 42. In some embodiments, the top width W_{T} may increase from the inlet end 40 toward the distal end 42. Alternatively, in embodiments, the top width W_{T} may decrease from the inlet end 40 towards the distal end 42. In some embodiments, the width of the base W_{B} of the trough 251 may increase from the inlet end 40 toward the distal end 42. Alternatively, in embodiments, the width of the base W_{B} of the trough 251 may decrease from the inlet end 40 towards the distal end 42.

The embodiments of forming bodies 250 schematically depicted in FIGS. 5A-5F and 6A-6F, which have troughs 251 that have trapezoidal-shaped vertical cross-sections, may have an outer shape and a mass flow rate over the first weir 260 and the second weir 280 that is the same as the outer shape and mass flow rate of the flow equivalent rectangular forming body 50 (FIGS. 2A-2C) while mitigating the outward bowing of the weirs that occurs in the flow equivalent rectangular forming body 50. Referring to FIGS. 5A, 5D, 6A, and 6D and as previously described in this disclosure, the outer shape of the forming body 250 is defined by the first outer surface 262, the first forming surface 44, the second forming surface 45, and the second outer surface 282 of the forming body 250. In the embodiments described herein, the length L_{T} and the outer width W_{O} of the forming body 250 may be the same as the length L_{T} and the outer width W₂ (FIG. 2B) of the flow equivalent rectangular forming body 50. Additionally, the upper portion height H_{U} of the forming body 250 at each point along the length L of the forming body 250 from the inlet end 40 to the distal end 42 of the trough 251 may be the same as the upper portion height H_{U} of the flow equivalent rectangular forming body 50 at the same points along the length L of the flow equivalent rectangular forming body 50 from the inlet end 40 to the distal end 42. Maintaining the outer shape of the forming body 250 the same as the outer shape of the flow equivalent rectangular forming body 50 maintains the flow dynamics of the molten glass down the first outer surface 262 and first forming surface 44 to the root 46 and down the second outer surface 282 and second forming surface 45 to the root 46, which may result in a fusion formed glass sheet 12 (FIG. 1) that is the same as the fusion formed glass sheet produced by the flow equivalent rectangular forming body 50, before any bowing of the weirs has occurred. However, the reinforced portions 266 of the first and second weirs 260, 280 of forming body 250 reinforce the first and second weirs 260, 280 and mitigate bowing of the weirs 260, 280.

As previously described, reinforcing the first and second weirs 260, 280 (i.e., by thickening the first and second weirs 260, 280 at the base 253 of the trough 251 through incorporating a trough 251 having a trapezoidal-shaped vertical cross-section) to mitigate bowing changes the flow characteristics of the forming body 250. Therefore, reinforcement of the first and second weirs 260, 280 should be done in a manner that maintains flow equivalency when the vertical cross-sectional area of the trough 251 is reduced. Reinforcement of the first and second weirs 260, 280 is accomplished without causing the forming body 250 to deviate from the flow equivalency curve for the target glass mass flow rate (e.g., such as the flow equivalency curve 90 depicted in FIG. 3) developed for the specific glass mass flow rate.

More specifically, to maintain flow equivalence of the forming body 250 with the flow equivalent rectangular forming body 50, one or more inner dimensions of the trough 251, first weir 260, second weir 280, base 253, or combinations of these may be varied to change the mass flow rate of molten glass over the first weir 260 and the second weir 280. By incorporating a first inner surface 261 and a second inner surface 281 that are sloped toward the center of the trough 251, the length of the flow path of molten glass from the bottom of the trough 251 (i.e., the base 253 of the trough 251) to the tops 263 of the first weir 260 and the second weir 280 may be reduced, which may reduce the impedance to the mass flow of molten glass from the inlet end 40 of the trough 251 to the tops 263 of the first weir 260 and the second weirs 280. As previously discussed, a reduction in impedance of the mass flow of molten glass to the tops 263 of the first weir 260 and the second weir 280 may increase the flow rate of molten glass over the tops 263 of the first and second weirs 260, 280 as compared to the flow equivalent rectangular forming body 50 having the same cross-sectional area. However, to compensate for this change in mass flow, the vertical cross-sectional area of the trough 251 of the forming body 250 may be further reduced to increase the impedance to flow of the molten glass through the trough 251 and thereby reduce the mass flow rate of the molten glass over the first and second weirs 260, 280 to provide the same mass flow rate of molten glass as the flow equivalent rectangular forming body 50.

In embodiments, the vertical cross-sectional area of the trough 251 of the forming body 250 may be decreased by decreasing the weir height H_{W} (i.e., making the trough 251 shallower while maintaining the upper portion height H_{U} the same as the flow equivalent rectangular forming body 50), changing the top thickness T_{T} of the first and second weirs 260, 280, making other adjustments to the geometry, or combinations thereof. Thus, the vertical cross-sectional area of the trough 251 is further decreased so that a plot of the hydraulic diameter versus the vertical cross-sectional area for the trough 251 of the forming body 250 remains on the flow equivalency curve for the target glass mass flow rate (e.g., such as the flow equivalency curve 90 depicted in FIG. 3) produced for the flow equivalent rectangular forming bodies 50 having the same mass flow rate of molten glass.

The forming bodies 250 having trapezoidal-shaped cross-sections may provide better resistance to weir spreading compared to the flow equivalent rectangular forming bodies 50, while maintaining the molten glass flow characteristics (i.e., mass flow and flow dynamics along the outer surfaces of the forming body 150). The forming body 250 may also provide better resistance to weir spreading without relying on application of compressive forces.

### EXAMPLES

The embodiments described herein will be further clarified by the following examples. Unless indicated, the examples are based on mathematical modeling of the forming body using the GOMA software.

### Example 1

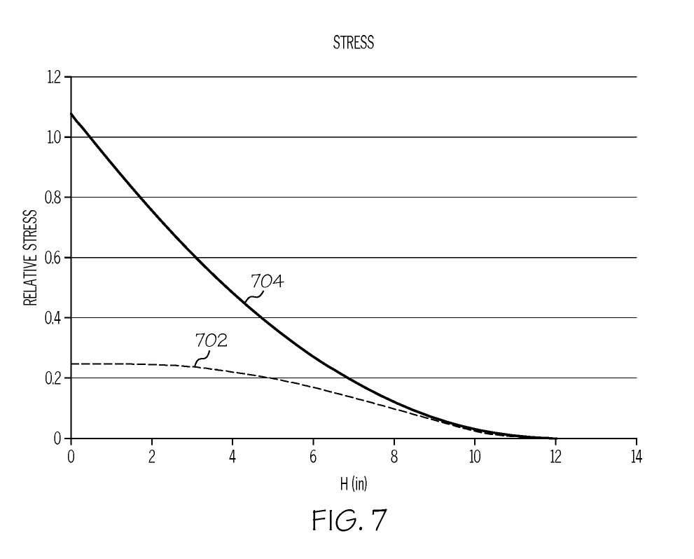

The calculated bending stress was modeled for a forming body 150 having the configuration depicted in FIGS. 4A-4F. The forming body 150 had a trough width of 8 inches and a trough depth (i.e., weir height H_{W}) of 12 inches. The first inner surface 161 of the first weir 160 and the second inner surface 181 of the second weir 180 were shaped to conform to the contour created by the moment curve function of Equation 2. The relative bending stress was calculated at the inlet end 40 of the trough 151, at which point the weir height H_{W}, and thus the bending stresses, are greatest. FIG. 7 shows the calculated relative bending stress 702 for a curved weir of the forming body 150 of FIGS. 4A-4F. The bending stress was also modeled for a comparative example of a flow equivalent rectangular forming body 50 depicted in FIGS. 2A and 2B and having a weir thickness T₁, T₂ of 2 inches. The results of the relative bending stress modeling for the flow equivalent rectangular forming body 50 are also provided in FIG. 7 as rectangular weir bending stress 704. The relative bending stress is provided in FIG. 7 as a function of distance from the bottom of the trough 151 (i.e., the base 153 of the trough 151).

As shown in FIG. 7, addition of the tapered reinforcement greatly reduced the bending stress experienced by the bottom portion of the weirs. The tapered reinforcement significantly reduced stress by increasing the area moment of inertia and section modulus. The stress in the bottom 3 inches of the weir may be reduced by as much as 60% to 75%.

### Example 2

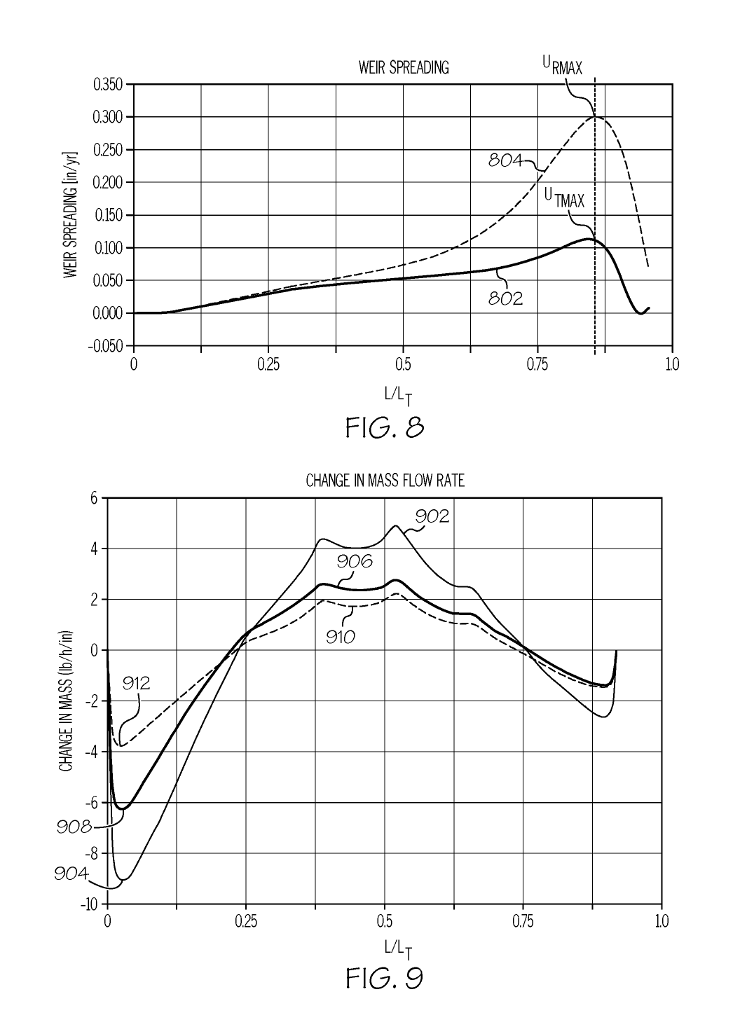

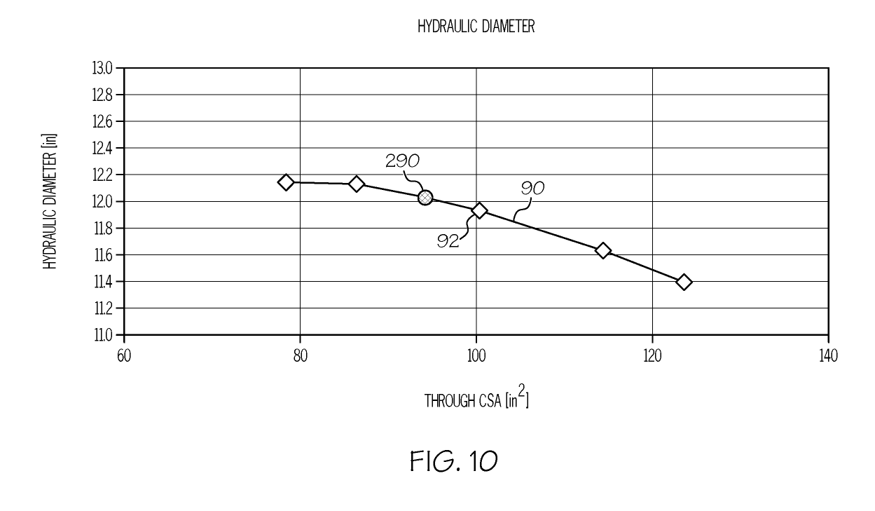

The rate of weir spreading was modeled for a forming body 250 having a configuration depicted in FIGS. 5A-5F having a trough 251 with a trapezoidal-shaped cross-section. The weir height H_{W} at the inlet end 40 of the trough 251 was set to 12.95 inches, the top thickness T_{T} of the first and second weirs 260, 280 at the inlet end 40 of the trough 251 were set to 1.025 inches, and the reinforced thickness T_{R} at the inlet end 40 of the trough 251 was set to 3.525 inches. The width of the base W_{B} of the trough 251 at the inlet end 40 was set to 4.70 inches. The weir height H_{W} decreased generally linearly from the inlet end 40 to the distal end 42 of the trough 251, while the width of the base W_{B} and slope angle α of the inner surfaces 261, 281 of the first and second weirs 260, 280, respectively, were maintained constant along the trough length L_{T}. At the inlet end 40 of the trough 251, the vertical cross-sectional area of the trough 251 was 94 square inches (in²) and the wetted perimeter of the trough was 31 inches. The calculated hydraulic diameter of the forming body 250 was 12.0 inches. The plot of the cross-sectional area and hydraulic diameter of the trough 251 are shown in FIG. 9 and identified by reference number 290. FIG. 9 also includes the flow equivalency curve 90 for flow equivalent rectangular forming bodies 50. As shown in FIG. 9, the plot 290 of cross-sectional area and hydraulic diameter of the trough 251 falls on the flow equivalency curve 90 indicating that the glass mass flow over the weirs 260, 280 of the forming body 250 of Example 2 is the same as the flow equivalent rectangular forming bodies 90 used to develop the flow equivalency curve 90.

The modeled rate of weir spreading per year as a function of the relative distance along the length of the trough 251 from the distal end 42 (i.e., the distal end 42 is set to x=0 in FIG. 8) to the inlet end 40 of the forming body 250 is provided in FIG. 8 and identified by reference number 802. For comparison, the rate of weir spreading was modeled for a flow equivalent rectangular forming body 50 having rectangular weirs and a rectangular-shaped trough 51, as depicted in FIGS. 2A-2C. The flow equivalent rectangular forming body 50 had a weir height H_{W} of 12.95 inches, a weir thickness T₁, T₂ of 2 inches, and a trough inner width W₁ of 7.75 inches. The plot of cross-sectional area vs. hydraulic diameter for the flow equivalent rectangular forming body 50 having a weir height of 12.95 inches and weir thickness of 2 inches is indicated by reference number 92 in FIG. 9, which lies on the flow equivalency curve 90. The same thermal and mechanical loading conditions were used for both models. The modeled rate of weir spreading for the flow equivalent rectangular forming body 50 is provided in FIG. 8 and identified by reference number 804.

As shown in FIG. 8, the rate of weir spreading 802 for the forming body 250 having a trapezoidal trough 251 exhibited a maximum rate of weir spreading U_{T,MAX} at a relative length of about 0.85 (i.e., at 85% of the trough length L_{T}) from the distal end 42 of the forming body 250. The comparative example of the flow equivalent rectangular forming body 50 had a maximum rate of weir spread U_{R,MAX} at about the same position, relative length of 0.85 from the distal end 42 of the forming body 50. The forming body 250 having the trapezoidal-shaped trough 251 exhibited a U_{T,MAX} that was 63% less than U_{R,MAX} of the flow equivalent rectangular forming body 50. Thus, reinforcement of the weirs 260, 280 of the forming body 250 to create a trough 251 having a trapezoidal cross-section may provide a reduction in the maximum rate of weir spreading of up to 63%.

### Comparative Example 1

The flow change of a flow equivalent rectangular forming body 50 of FIGS. 2A-2C after a fixed period of operation at a constant production rate was calculated from actual autopsy measurements of weir sag and weir spreading following decommissioning of the rectangular forming body 50. The flow equivalent rectangular forming body 50 was made from zircon refractory material. The predicted flow change 902 for the flow equivalent rectangular forming body 50 is graphically depicted in FIG. 9 as a function of the relative distance from the inlet end 40 of the forming body 50. As shown in FIG. 9, the maximum flow change 904 (i.e., maximum absolute value of the flow change) occurs at a relative length of about 0.05 from the inlet end 40 of the forming body 50, at which point the mass flow of glass over the weir is shown to decrease by more than 8 pounds per hour per inch (lb/hr/in).

### Comparative Example 2

The flow change of a second flow equivalent rectangular forming body 50 of FIGS. 2A-2C after a fixed period of operation at a constant production rate was modeled. The dimensions of the flow equivalent rectangular forming body 50 of Comparative Example 2 were the same dimensions as the flow equivalent rectangular forming body 50 of Comparative Example 1, but Comparative Example 2 was modeled using low creep zircon refractory material as the material of construction. Low creep zircon refractory material exhibits greater resistance to weir spreading compared to the normal zircon refractory materials. The modeled flow change 906 for the flow equivalent rectangular forming body 50 of Comparative Example 2 is graphically depicted in FIG. 9 as a function of the distance from the inlet end 40 of the forming body 50. As shown in FIG. 9, the maximum flow change 908 (i.e., maximum absolute value of the flow change) occurs at a relative length of about 0.05 from the inlet end 40 of the forming body 50, at which point the mass flow of glass over the weir is shown to decrease by more than 6 lb/hr/in. As expected, use of a different material, which is more resistant to weir spreading, results in the maximum flow change 908 for Comparative Example 2 being less than the maximum flow change 904 for Comparative Example 1.

### Example 3

The flow change of a third flow equivalent rectangular forming body 50 of FIGS. 2A-2C was modeled after a fixed period of operation at a constant production rate. The dimensions of the rectangular forming body 50 of Example 3 were the same dimensions as the flow equivalent rectangular forming body 50 of Comparative Example 1, but Example 3 was modeled using low creep zircon refractory materials as the material of construction. Additionally, the third forming body of Example 3 was modeled with the weir spreading effect removed from the simulation to show the positive impact of reducing weir spreading. The modeled flow change 910 for the rectangular forming body of Example 3 is graphically depicted in FIG. 9 as a function of the distance from the inlet end 40 of the forming body 50. As shown in FIG. 9, the maximum flow change 912 (i.e., maximum absolute value of the flow change) occurs at relative length of about 0.05 from the inlet end 40 of the forming body 50, at which point the mass flow of glass over the first and second weirs 60, 80 is shown to decrease by less than 5 lb/hr/in. The maximum flow change 912 of the forming body 50 of Example 3, which has the weir spreading effect removed from the simulation, exhibits a 45% improvement in flow change as compared to the maximum flow change 908 of Comparative Example 2, which is constructed of the same material but includes the effects of weir spreading in the simulation. Therefore, removing the weir spreading effect from the simulation is shown to result in an extension in the service life of the forming body 50 of Example 3 of about 1.8 times the service life of the flow equivalent rectangular forming body 50 of Comparative Example 2.

The estimation of improvement in service life assumes no weir spreading occurs, which would be the maximum improvement. To estimate the actual improvement in service life, the maximum improvement in service life of 1.8 times the service life of the flow equivalent rectangular forming body 50 of Comparative Example 2 may be multiplied by the reduction in weir spreading of 63% from Example 2. The resulting estimated The resulting estimated improvement in service life for the forming body 50 of Example 3, which does not factor in weir spreading, is about 1.5 times the estimated service life of the flow equivalent rectangular forming body 50 of Comparative Example 2.

Based on the foregoing, it should now be understood that the embodiments described herein relate to forming bodies for use in glass forming apparatuses. The forming bodies described herein may be constructed to mitigate the onset of outward bowing of the weirs of the forming body due to material creep and the pressure of molten glass against the inner vertical surfaces of the weirs, thereby extending the service life of the forming bodies.

While various embodiments and techniques for mitigating the onset of outward bowing of the weirs of the forming bodies have been described herein, it should be understood it is contemplated that each of these embodiments and techniques may be used separately or in conjunction with one or more embodiments and techniques.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A forming body of a glass forming apparatus comprising:
a trough for receiving molten glass, the trough comprising a first weir, a second weir spaced apart from the first weir, a base extending between the first weir and the second weir, an inlet end, a distal end opposite the inlet end, and a length extending from the inlet end to the distal end, wherein:
the first weir and the second weir each comprise a sloped inner surface extending from the base to a top of the respective weir, the sloped inner surface oriented at an angle with respect to a vertical plane,
a width of the base of the trough is less than a top width of the trough such that the trough is trapezoidal in cross-section for at least a portion of the length,
the top width of the trough is constant from the inlet end to the distal end of the trough, and
the angle between the sloped inner surface and the vertical plane varies along the at least a portion of the length.

2. The forming body of claim 1, wherein the width of the base of the trough is constant from the inlet end to the distal end of the trough.

3. The forming body of claim 1, wherein the width of the base of the trough varies along at least a portion of the length.

4. The forming body of claim 3, wherein the width of the base of the trough increases from the inlet end of the trough towards the distal end of the trough.

5. The forming body of claim 1, wherein the angle between the sloped inner surface and the vertical plane decreases from the inlet end of the trough towards the distal end of the trough.

6. The forming body of claim 1, wherein the angle between the sloped inner surface and the vertical plane increases from the inlet end of the trough towards the distal end of the trough.

7. The forming body of claim 1, wherein the at least a portion of the length extends the entire length from the inlet end to the distal end of the trough.

8. The forming body of claim 1, wherein the at least a portion of the length extends from the inlet end of the trough to a distance from 0.25 to 0.5 times the length.

9. A forming body of a glass forming apparatus comprising:
a trough for receiving molten glass, the trough comprising a first weir, a second weir spaced apart from the first weir, a base extending between the first weir and the second weir, an inlet end, a distal end opposite the inlet end, and a length extending from the inlet end to the distal end, wherein:
the first weir and the second weir each comprise a sloped inner surface extending from the base to a top of the respective weir, the sloped inner surface oriented at an angle with respect to a vertical plane, and
a width of the base of the trough is less than a top width of the trough such that the trough is trapezoidal in cross-section for at least a portion of the trough length;
the width of the base of the trough is constant from the inlet end to the distal end of the trough; and
the top width of the trough varies along the at least a portion of the length.

10. The forming body of claim 9, wherein the angle between the sloped inner surface and the vertical plane is constant from the inlet end to the distal end of the trough.

11. The forming body of claim 9, wherein the angle between the sloped inner surface and the vertical plane varies along at least a portion of the length.

12. The forming body of claim 11, wherein the angle between the sloped inner surface and the vertical plane increases from the inlet end towards the distal end of the trough.

13. The forming body of claim 9, wherein the top width of the trough decreases from the inlet end towards the distal end of the trough.

14. The forming body of claim 9, wherein the top width of the trough increases from the inlet end towards the distal end of the trough.

15. The forming body of claim 9, wherein the at least a portion of the length extends the entire length from the inlet end to the distal end.

16. The forming body of claim 9, wherein the at least a portion of the length extends from the inlet end of the trough to a distance from 0.25 to 0.5 times the length.

17. A forming body of a glass forming apparatus comprising:
a trough for receiving molten glass, the trough comprising a first weir, a second weir spaced apart from the first weir, a base extending between the first weir and the second weir, an inlet end, a distal end opposite the inlet end, and a length extending from the inlet end to the distal end, wherein:
the first weir and the second weir each comprise a top comprising a top thickness, and a sloped inner surface oriented at an angle relative to a vertical plane;
a width of the base of the trough is less than a top width of the trough such that the trough is trapezoidal in cross-section and varies along at least a portion of the length;
the angle between the sloped inner surface and the vertical plane is constant from the inlet end to the distal end of the trough; and
the width of the base of the trough varies along the at least a portion of the trough length.

18. The forming body of claim 17, wherein the top width of the trough is constant from the inlet end to the distal end of the trough.

19. The forming body of claim 17, wherein the top width of the trough varies along the at least a portion of the length.

20. The forming body of claim 19, wherein the top width of the trough decreases from the inlet end towards the distal end of the trough.

21. The forming body of claim 17, wherein the width of the base of the trough decreases from the inlet end towards the distal end of the trough.

22. The forming body of claim 17, wherein the width of the base of the trough increases from the inlet end towards the distal end of the trough.

23. The forming body of claim 17, wherein the at least a portion of the length extends the entire length from the inlet end to the distal end of the trough.

24. The forming body of claim 17, wherein the at least a portion of the length extends from the inlet end of the trough to a distance from 0.25 to 0.5 times the length.

25. A forming body of a glass forming apparatus comprising:
a trough for receiving molten glass, the trough comprising a first weir, a second weir spaced apart from the first weir, a base extending between the first weir and the second weir, an inlet end, a distal end opposite the inlet end, and a length extending from the inlet end to the distal end, wherein:
the first weir and the second weir each comprise a top comprising a top thickness, and a sloped inner surface oriented at an angle with respect to a vertical plane;
a width of the base of the trough is less than a top width of the trough such that the trough is trapezoidal in cross-section for at least a portion of the length;
the angle between the sloped inner surface and the vertical plane, the top width of the trough, and the width of the base of the trough vary along the at least a portion of the length.

26. The forming body of claim 25, wherein the angle between the sloped inner surface and the vertical plane increases from the inlet end towards the distal end of the trough.

27. The forming body of claim 25, wherein the angle between the sloped inner surface and the vertical plane decreases from the inlet end towards the distal end of the trough.

28. The forming body of claim 25, wherein the top width of the trough increases from the inlet end towards the distal end of the trough.

29. The forming body of claim 25, wherein the top width of the trough decreases from the inlet end towards the distal end of the trough.

30. The forming body of claim 25, wherein the width of the base of the trough increases from the inlet end towards the distal end of the trough.

31. The forming body of claim 25, wherein the width of the base of the trough decreases from the inlet end towards the distal end of the trough.

32. The forming body of claim 25, wherein the angle between the sloped inner surface and the vertical plane, the top width of the trough, and the width of the base vary along the entire length from the inlet end to the distal end of the trough.

33. The forming body of claim 25, wherein the angle between the sloped inner surface and the vertical plane, the top width of the trough, and the width of the base vary from the inlet end of the trough towards the distal end to a distance from 0.25 to 0.5 times the length.

34. A forming body of a glass forming apparatus comprising:
a trough for receiving molten glass, the trough comprising a first weir, a second weir spaced apart from the first weir, a base extending between the first weir and the second weir, an inlet end, a distal end opposite the inlet end, and a length extending from the inlet end to the distal end, wherein:
the first weir and the second weir each comprise a top comprising a top thickness, and a reinforcing portion extending upward from the base towards the top;
each reinforcing portion comprises a curved inner surface;
the base of the trough extends between the curved inner surface of the first weir and the curved inner surface of the second weir; and
a width of the base of the trough is less than a top width of the trough along at least a portion of the length of the trough.

35. The forming body of claim 34, wherein the reinforcing portion of the first weir extends from the base of the trough to the top of the first weir and the reinforcing portion of the second weir extends from the base of the trough to the top of the second weir.

36. The forming body of claim 34, wherein the first weir and the second weir each comprise a vertical portion extending from the reinforcing portion to the top of the first weir and the second weir.

37. The forming body of claim 36, wherein the vertical portion has a vertical inner surface.

38. The forming body of claim 36, wherein a ratio of a height of the reinforcing portion to a weir height decreases from the inlet end towards the distal end of the trough along at least a portion of the length.

39. The forming body of claim 34, wherein a curvature of the curved inner surface is a concave curvature.

40. The forming body of claim 34, wherein a curvature of the curved inner surface varies along at least a portion of the length.

41. The forming body of claim 40, wherein a curvature of the curved inner surface decreases along at least a portion of the length.

42. The forming body of claim 34, wherein a curvature of the curved inner surface is a parabolic curvature.

43. The forming body of claim 42, wherein a weir thickness at each point along the parabolic curvature of the curved inner surface is proportional to a bending stress exerted on the first weir or the second weir by molten glass flowing through the trough.
